(19) United States
(12) Patent Application Publication
(10) Pub. No.: US 2011/0235484 A1
(43) Pub. Date: Sep. 29, 2011

(54) RECORDING DEVICE AND RECORDING METHOD

(75) Inventor: Junichi Horigome, Tokyo (JP)

(73) Assignee: Sony Corporation, Tokyo (JP)

(21) Appl. No.: 13/039,997

(22) Filed: Mar. 3, 2011

(30) Foreign Application Priority Data
Mar. 23, 2010 (JP) 2010-066153

(51) Int. Cl. G11B 7/0037

(52) U.S. Cl. 369/44.33; 369/44.39; 369/44.38; G9B/7.005

(57) ABSTRACT

In one example embodiment, a recording apparatus includes a laser and a controller. In one example embodiment, the recording apparatus records a second recording track on a recording medium which includes a first recording track which was previously recorded on the recording medium. In one example embodiment, the second recording track is gradually enlarged until a first separation distance exceeds a distance which corresponds to at least twice a number of maximum deviation tracks of the first recording track.

### CROSS REFERENCES TO RELATED APPLICATIONS

The present application claims priority to Japanese Patent Application No. JP 2010-066153, filed in the Japanese Patent Office on Mar. 23, 2010 the entire contents of which is being incorporated herein by reference.

### BACKGROUND

As an optical recording medium for performing recording/reproduction of a signal by light irradiation, for example, a so-called optical disc such as a Compact Disc (CD), Digital Versatile Disc (DVD) or Blu-ray Disc (BD) (registered trademark) have come into wide use.

With respect to an optical recording medium (which is a next-generation optical recording medium widely used in the present state of the CD, the DVD, the BD and the like), the present applicant proposes in advance a so-called bulk recording type optical recording medium as described in Japanese Unexamined Patent Application Publication No. 2008-135144 or 2008-176902.

Here, bulk recording means, for example, a technology of realizing a large amount of recording capacity by sequentially changing a focusing position and irradiating a laser beam to an optical recording medium having at least a cover layer 101 and a bulk layer 102 so as to perform multi-layer recording in the bulk layer 102, as illustrated in FIG. 21.

In such bulk recording, Japanese unexamined Patent Application Publication No. 2008-135144 discloses a recording technology which is a so-called micro hologram method.

The micro hologram method is classified broadly into a positive type micro hologram method and a negative type micro hologram, as illustrated in FIGS. 22A and 22B.

In the micro hologram method, a so-called hologram recording material is used as a recording medium for the bulk layer 102. As the hologram recording material, for example, a photopolymerizable photopolymer is widely known.

As illustrated in FIG. 22A, the positive type micro hologram method is a method of focusing two opposing light fluxes (e.g., light flux A and light flux B) at the same position so as to form a minute interference fringe (hologram) and using the minute interference fringe as a recording mark.

The negative type micro hologram method illustrated in FIG. 22B is a method of erasing an interference fringe formed in advance by laser beam irradiation and using the erased portion as a recording mark, in opposition to the positive type micro hologram method.

FIG. 23 is a diagram illustrating the negative type micro hologram method.

In the negative type micro hologram method, before performing a recording operation, as illustrated in FIG. 23A, an initialization process for forming an interference fringe in the bulk layer 102 is performed in advance. Specifically, as illustrated in the drawing, light fluxes C and D from parallel lights are oppositely irradiated so as to form such an interference fringe in the overall bulk layer 102.

After the interference fringe is formed in advance by the initialization process, as illustrated in FIG. 23B, information recording is performed by forming an erasing mark. Specifically, by irradiating a laser beam according to recording information in a state of focusing on an arbitrary layer position, information recording by using the erasing mark is performed.

The present applicant proposes, moreover, a recording method of forming a void (hole) as a recording mark disclosed in Japanese Unexamined Patent Application Publication No. 2008-176902, as another bulk recording method.

The void recording method is, for example, a method of irradiating a laser beam with relatively high power to the bulk layer 102 formed of a recording material such as a photopolymerizable photopolymer so as to record a hole (void) in the bulk layer 102. As described in Japanese Unexamined Patent Application Publication No. 2008-176902, the formed hole portion in this way has a refractive index different from that of the other portion of the bulk layer 102 and thus the light reflection ratio of the boundary portion thereof is increased. Accordingly, the hole portion functions as a recording mark and thus information recording by formation of a hole mark is realized.

In such a void recording method, because a hologram is not formed, recording is completed by light irradiation from one side. That is, it is not necessary to focus two light fluxes at the same position so as to form the recording mark, in the positive type micro hologram method, and high positional control precision for focusing two light fluxes at the same position is not necessary.

In the negative type micro hologram method or the void recording method, the case where a laser beam is irradiated from one side of a recording medium so as to perform recording/reproduction is considered.

Such methods are different in principle but are alike in the general idea that only a light from one side enters a volume type recording medium having a bulk layer and only a focusing position is changed in the bulk layer 102 so as to perform multi-layer recording.

In such recording methods, each recording layer itself formed in the bulk layer 102 does not have address information. In more detail, the recording layer is formed by recording of a recording mark and thus the recording layer is not present before recording.

In general, an optical disc of the related art has zigzag guide grooves which are called wobbling grooves and detects a frequency thereof so as to obtain positional information. However, in the negative type micro hologram method or the void recording method, because the recording layer including the wobbling grooves are not formed in the bulk layer 102 in advance, the address information of each recording layer may not be applied in this method.

With respect to the recording medium in which the address information or the like may not be directly detected from the inside of the recording bulk layer 102, a servo reference surface (reference surface) is provided separately from a recording/reproducing surface and, by a signal obtained therefrom, the recording position in the bulk layer 102 is controlled.

In this case, two beams of a recording/reproducing optical system (recording/reproducing laser beam) and a control optical system (servo laser beam) are used. For example, in such a light source, there is a case in which a blue laser, a red laser, and the like are used.

If the compatibility of the recording medium (that which is recorded by a device A is reproduced or additionally recorded by a device B) and additional recording are considered, it is necessary to match the positional relationship between spots of the recording/reproducing laser beam and the servo laser beam with high precision (submicron precision). However, this is extremely difficult due to adjustment precision (misalignment) of an optical system, a change of time, expansion and contraction due to temperature, error due to slope (tilt) of a disc, error due to movement (visual field movement) of an objective lens due to eccentricity and the like.

In particular, the disc tilt and the visual field movement due to eccentricity which cause a large spot shift will be described.

FIG. 24A is a schematic diagram showing a cross-sectional structure of a disc 100 as a bulk type optical recording medium used in a negative type micro hologram or a void recording method. In this case, a reference surface 103 is formed between a cover layer 101 and a bulk layer 102.

For example, wobbling grooves are formed in the reference surface 103 so as to apply address information.

A recording/reproducing device of this disc 100 irradiates two laser beams (e.g., a recording/reproducing laser beam LZ1 and a servo laser beam LZ2) from one objective lens 200 as illustrated in the drawing.

The servo laser beam LZ2 is focus-controlled to the reference surface 103 and tracking control or address decoding is performed from information on the returning light of the reference surface 103.

The recording/reproducing laser beam LZ1 is focus-controlled with an offset of a depth direction of the disc 100 from the servo laser beam LZ2 focused-controlled to the reference surface 103. A recording mark is formed in the bulk layer 102 by the recording/reproducing laser beam LZ1 so as to form a recording layer.

In order to match the address information of the reference surface 103 to the recording information of the recording layer formed by the recording/reproducing laser beam LZ1, as illustrated in FIG. 24A, a deviation between the spots of the laser beams LZ1 and LZ2 in a radial direction is substantially 0. The center axis c of the drawing is the center axis set in the design of the optical system.

If a state in which the disc 100 and the optical system (e.g., objective lens 200) face each other is inclined and, as illustrated in FIG. 24B and a focal position deviation Δx of the radio direction of the disc 100 relative to both spots is present by the skew of the disc 100 relative to the laser incident optical axis, matching of the recorded data and the address by the wobbling grooves becomes inaccurate.

In addition, FIG. 24C illustrates an incident optical axis J, a tilt amount θ, the focal position deviation Δx between the spots of the laser LZ1 and LZ2, a distance Δt in a disc thickness direction between the laser beams LZ1 and LZ2, a refractive index N of the disc 100, and a disc thickness t. The focal position deviation Δx between the spots satisfies Δx=(θ/N)·Δt.

The visual field movement caused by eccentricity will be described with reference to FIGS. 25A to 25C.

During recording, the objective lens 200 is driven so as to follow the eccentricity of the disc 100 by tracking servo control (that is, a lens shift occurs). Accordingly, a deviation between the spot position of the servo laser beam LZ2 and the spot position (that is, information recording position) of the recording/reproducing laser beam LZ1 in a tracking direction occurs.

FIG. 25A illustrates an ideal state in which eccentricity does not occur in a bulk type recording medium D2, FIG. 25B illustrates the case where eccentricity occurs in a left direction (referred to as an outer circumferential direction) of the drawing (referred to as eccentricity of a plus (+) direction), and FIG. 25C illustrates the case where eccentricity occurs in a right direction (referred to as an inner circumferential direction) of the drawing (referred to as eccentricity of a minus (−) direction).

In the ideal state illustrated in FIG. 25A, the center of the objective lens 200 matches to the center axis c. In this state, the spot positions of the servo laser beam LZ2 and the recording/reproducing laser beam LZ1 in the tracking direction match each other.

On the other hand, if eccentricity of the plus (+) as illustrated in FIG. 25B occurs, the objective lens 200 is driven by tracking servo control in the plus (+) so as to follow eccentricity. That is, the center of the objective lens 200 is shifted in the plus (+) with respect to the center axis c of the optical system.

At this time, the servo laser beam LZ2 enters the objective lens 200 as a parallel light, but the recording/reproducing laser beam LZ1 is focused on a necessary information recording layer position in the bulk layer 102 located at a lower layer side of the reference surface 103 so as to enter the objective lens 200 as a non-parallel light.

To this end, in the shift of the objective lens 200 in the plus (+) direction as described above, as illustrated in the drawing, a deviation in the plus (+) direction occurs between the spot position (information recording position) of the recording/reproducing laser beam LZ1 and the spot position of the servo laser beam LZ2 by an eccentric amount (in the drawing, a deviation +d).

If eccentricity of the minus (−) direction illustrated in FIG. 25C occurs, the objective lens 200 is shifted by tracking servo control in the minus (−) direction so as to follow eccentricity of the minus (−) direction. To this end, a deviation in the minus (−) direction occurs between the spot position of the recording/reproducing laser beam LZ1 and the spot position of the servo laser beam LZ2 by an eccentric amount (in the drawing, a deviation −d) as illustrated in the drawing.

The deviation in the tracking direction between the spot position of both laser beams LZ1 and LZ2 illustrated in FIGS. 24A to 25C causes a deviation between the recording track actually recorded in the bulk layer 102 and the recording track defined by the reference surface 103.

For example, FIG. 26 illustrates an example of a recording track recorded when being influenced by tilt or eccentricity.

In FIG. 26, a dotted line denotes an ideal track (hereinafter, referred to as an ideal track) defined by grooves or pit rows of the reference surface 103 and a solid line denotes an actual recording track formed in an information recording layer in the bulk layer 102. Here, information recording is performed in a range of positions P1 to P2 so as to form the recording track.

While tracking servo is performed based on the reflected light from the grooves or the like of the reference surface 103 of the servo laser beam LZ2, recording is performed in the bulk layer 102 by the recording/reproducing laser beam LZ1, such that the recording track is formed in a spiral shape while maintaining the same track pitch as the ideal track. However, by the deviation between the spots of both the above-described laser beams LZ1 and LZ2, the recording track is deviated from the ideal track. For example, the spiral shape becomes almost an elliptic shape while straddling the ideal track.

The tilt state or the eccentric state is generated in different forms whenever the disc is loaded by a difference in the recording device or the clamping of the disc to a spindle motor. For example, when additional recording is performed with respect to a certain disc, because the form of eccentricity or tilt generated during previous recording and the form of eccentricity or tilt generated during additional recording are different, the mark string (recording track) of the previously recorded part and the mark string (recording track) of the additionally recorded part may overlap and cross according to the circumferences.

For example, it is assumed that additional recording is performed from a position P2 with respect to the disc of the state illustrated in FIG. 26. It is assumed that, after recording is performed up to the position P2, the disc is taken out of the recording device and then is loaded into the recording device or another recording device.

When being newly loaded, the tilt state or the eccentric state is changed. Then, as denoted by a thick line in FIG. 27, when additional recording is performed from the position P2 so as to form the recording track, the track pitch with the recorded recording track is not maintained and the additionally recorded recording track overlap or crosses. This is because, even during additional recording, tracking servo control based on the ideal track of the reference surface 103 is performed, but the states of the spot positions of the laser beams LZ1 and LZ2 are different in the previous recording and in the additional recording.

If such a situation occurs, the recorded data is destroyed by additional recording and an extremely important problem occurs

On the other hand, it is difficult to prevent deviation between the spot positions of both the laser beam LZ1 and LZ2 in consideration of all events such as the tilt state, the eccentric state, adjustment precision, a change with time, expansion and contraction due to temperature.

The track pitch may widen such that the overlapping or crossing of the recording tracks does not occur through position deviation. However, in this case, it is difficult to handle a request for high-density recording.

It is desirable to appropriately perform recording/reproduction even when spot position deviation occurs, in the case where two laser beams are irradiated from one side of a recording medium to a bulk layer so as to perform recording/reproduction as in a negative type micro hologram method or a bulk recording method.

### SUMMARY

The present disclosure relates to a recording device and a recording method for recording/reproducing a signal on an optical recording medium by light irradiation.

In one example embodiment, a recording apparatus includes a laser and a controller operatively coupled to the laser. In one example embodiment, the controller is configured to, in cooperation with the laser, record a second recording track on a recording medium which includes a first recording track which was previously recorded on the recording medium. In one example embodiment, the second recording track is gradually enlarged until a first separation distance exceeds a distance which corresponds to at least twice a number of maximum deviation tracks of the first recording track.

In one example embodiment, the second recording track is gradually enlarged based on a variable track pitch control. In one example embodiment, the second recording track is gradually enlarged based on a fixed track pitch control.

In one example embodiment, the controller is configured to, based on a defect of the recording medium, record the second recording track at a position which is separated from an end position of the first recording track by a second separation distance.

In one example embodiment, the controller is configured to, after the second recording track is recorded, record a third recording track on the recording medium. In one example embodiment, the third recording track is gradually enlarged until a third separation distance exceeds a distance which corresponds to at least twice the number of maximum deviation tracks of the first recording track. In one example embodiment, the third recording track is gradually enlarged based on a variable track pitch control. In one example embodiment, the third recording track is gradually enlarged based on a fixed track pitch control.

In one example embodiment, the controller is configured to, after the third recording track is recorded, record a fourth recording track on the recording medium. In one example embodiment, the fourth recording track is gradually enlarged based on a fixed track pitch control.

In one example embodiment, the number of maximum deviation tracks is determined using a deviation amount which is based on a tilt state between the recording medium and an optical pickup and an eccentric state of the recording medium.

In one example embodiment, the second recording track includes dummy data.

In one example embodiment, the laser includes a first laser configured to irradiate a recording laser beam and a second laser configured to irradiate a servo laser beam. In one example embodiment, the recording apparatus includes an optical pickup which includes the first laser and the second laser.

In one example embodiment, the recording apparatus includes a servo circuit operatively coupled to the controller such that the controller is configured to perform tracking servo control of the recording laser beam.

In one example embodiment, the recording medium includes a bulk layer and a reference surface.

In one example embodiment, a method of operating a recording apparatus including a laser includes recording a second recording track on a recording medium which includes a first recording track which was previously recorded on the recording medium. In one example embodiment, the second recording track is gradually enlarged until a first separation distance exceeds a distance which corresponds to at least twice a number of maximum deviation tracks of the first recording track.

In one example embodiment, the second recording track is gradually enlarged based on a variable track pitch control. In one example embodiment, second recording track is gradually enlarged based on a fixed track pitch control.

In one example embodiment, the method includes recording, based on a defect of the recording medium, the second recording track at a position which is separated from an end position of the first recording track by a second separation distance.

In one example embodiment, the method includes, after the second recording track is recorded, recording a third recording track on the recording medium. In one example embodiment, the third recording track is gradually enlarged until a third separation distance exceeds a distance which corresponds to at least twice the number of maximum deviation tracks of the first recording track.

In one example embodiment, the third recording track is gradually enlarged based on a variable track pitch control.

In one example embodiment, the method includes, after the second recording track is recorded, recording a third recording track on the recording medium, the third recording track being gradually enlarged based on a fixed track pitch control.

In one example embodiment, the method includes, after the second recording track is recorded, recording a third recording track on the recording medium. In one example embodiment, the third recording track is gradually enlarged based on a fixed track pitch control.

In one example embodiment, the method includes, after the third recording track is recorded, recording a fourth recording track on the recording medium. In one example embodiment, the fourth recording track is gradually enlarged based on a fixed track pitch control.

In one example embodiment, the number of maximum deviation tracks is determined using a deviation amount which is based on a tilt between the recording medium and an optical pickup and an eccentric state of the recording medium.

In one example embodiment, the second recording track includes dummy data.

In one example embodiment, the laser includes a first laser configured to irradiate a recording laser beam and a second laser configured to irradiate a servo laser beam.

In one example embodiment, the method includes performing tracking servo control of the recording laser beam.

In one example embodiment, an optical pickup includes the first laser and the second laser.

In one example embodiment, the recording medium includes a bulk layer and a reference surface.

In the present disclosure, after the recording track is continuously formed as the sequential recording, for example, if ejection or the like occurs, the recording track corresponding to the additional recording is formed. This prevents overlapping with the existing recording track during subsequent additional recording, even when a deviation amount of the recording track from an ideal track is in a worse state with respect to the existing recording track. To this end, the recording track corresponding to additional recording is gradually enlarged until the separation distance of the track pitch direction with the recording track exceeds a distance corresponding to twice the maximum deviation track number.

The additional recording is performed continuously to the end of the recording track corresponding to the additional recording. At this time, for protection of the additionally recorded new data, the recording track during the start of additional recording is gradually enlarged until the separation distance of the track pitch direction with the recording track corresponding to additional recording becomes a distance corresponding to twice or more the maximum deviation track number. This prevents the additionally recorded recording track from overlapping the previous recording track (e.g., the recording track corresponding to the additional recording) during the additional recording, even when a deviation amount of the recording track from an ideal track is in a worse state with respect to the existing recording track.

In addition, if recording is performed with respect to a new disc or recording that was stopped due to a defect or the like is restarted, a running recording track corresponding to a radius direction distance exceeding a distance corresponding to twice the maximum deviation track number is formed. In one example embodiment, the running recording track is gradually enlarged with a fixed track pitch until a formation range of the running recording track exceeds a radius-direction distance which is at least twice the maximum deviation track number. This also determines a worse deviation amount.

According to the embodiments of the present disclosure, even when a deviation amount in a track pitch direction between the focusing position of a first laser beam and a focusing position of a second laser beam is present and a deviation state different from the past recording time occurs at an additional recording time, data is not destroyed due to the overlapping of recording tracks. Accordingly, it is possible to increase the reliability of recording data.

Thus, it is possible to narrow a general track pitch and to significantly increase recording capacity.

Additional features and advantages are described herein, and will be apparent from the following Detailed Description and the figures.

### BRIEF DESCRIPTION OF THE FIGURES

FIG. 1 is an explanatory diagram of a bulk recording medium according to an example embodiment of the present disclosure.

FIG. 2 is an explanatory diagram of servo control during recording of an example embodiment.

FIG. 3 is an explanatory diagram of servo control during reproduction of an example embodiment.

FIGS. 4A and 4B are explanatory diagrams of an SRR of a recording medium of an example embodiment.

FIG. 5 is a block diagram of a recording/reproducing device of an embodiment.

FIG. 6 is an explanatory diagram of a recording operation for forming a recording track corresponding to additional tracking and a recording track during the start of additional recording.

FIG. 7 is an explanatory diagram of a recording operation during recording start or restart of an embodiment.

FIG. 8 is a flowchart of a sequential recording process of an embodiment.

FIG. 9 is an explanatory diagram of pits formed in a reference surface of an embodiment.

FIG. 10 is an explanatory diagram of a pit forming form of a reference surface of an embodiment.

FIGS. 11A to 11C are explanatory diagrams of the format of address information by pits of an embodiment.

FIG. 12 is an explanatory diagram of a variable track pitch of an embodiment.

FIG. 13 is an explanatory of a signal obtained by pits of a reference surface of an embodiment.

FIG. 14 is an explanatory diagram of timing signal generation of an embodiment.

FIG. 15 is an explanatory diagram of a relationship among a clock, a selector signal and each pit row of an embodiment.

FIG. 16 is an explanatory diagram of method of realizing a variable track pitch of an embodiment.

FIG. 17 is a block diagram showing a tracking error generation unit of a recording/reproducing device of an example embodiment.

FIG. 18 is a block diagram of a clock generation circuit of an embodiment.

FIG. 19 is a flowchart illustrating tracking control in a fixed track pitch of an embodiment.

FIG. 20 is a flowchart illustrating tracking control in a variable track pitch of an embodiment.

FIG. 21 is an explanatory diagram of micro hologram recording.

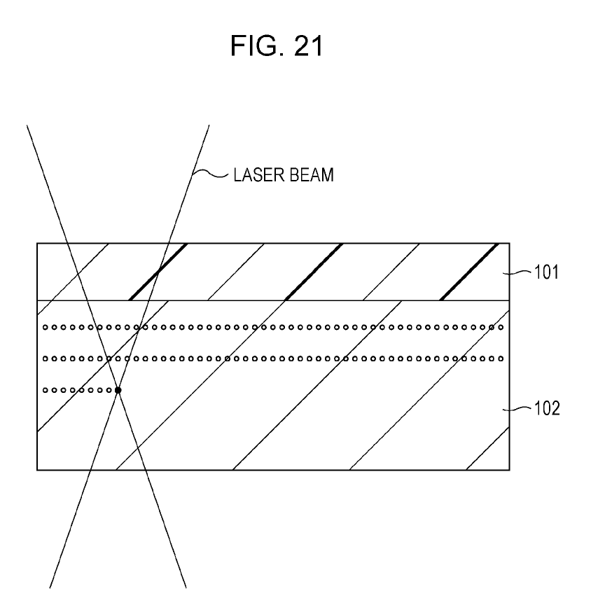

FIGS. 22A and 22B are explanatory diagrams positive and negative type micro hologram recording.

FIGS. 23A and 23B are explanatory diagrams of negative type micro hologram recording.

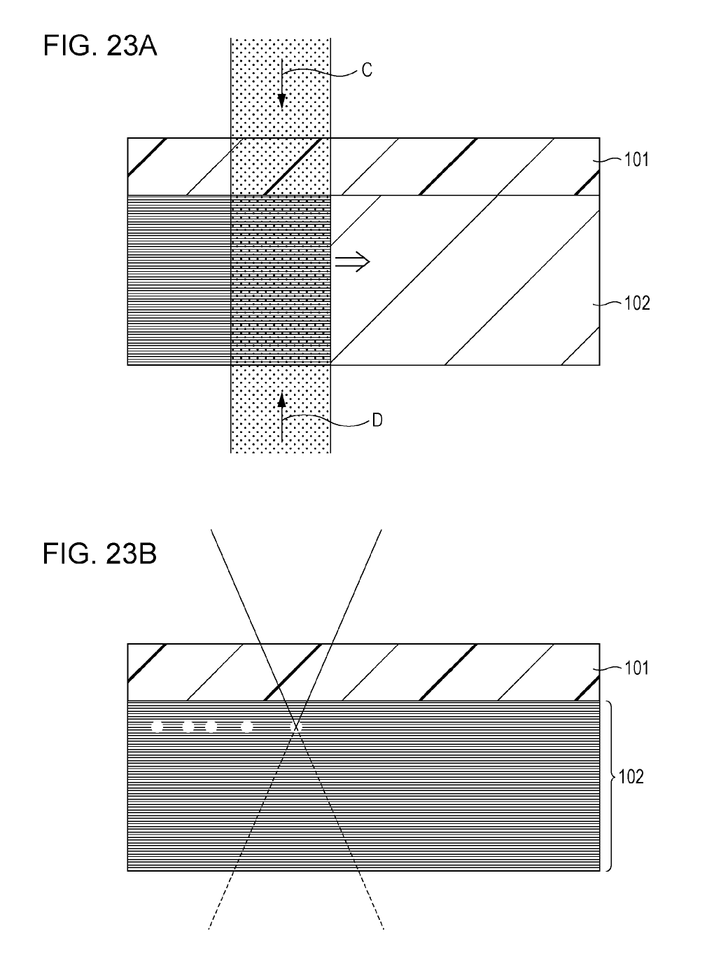

FIGS. 24A to 24C are explanatory diagrams of a spot deviation by disc skew.

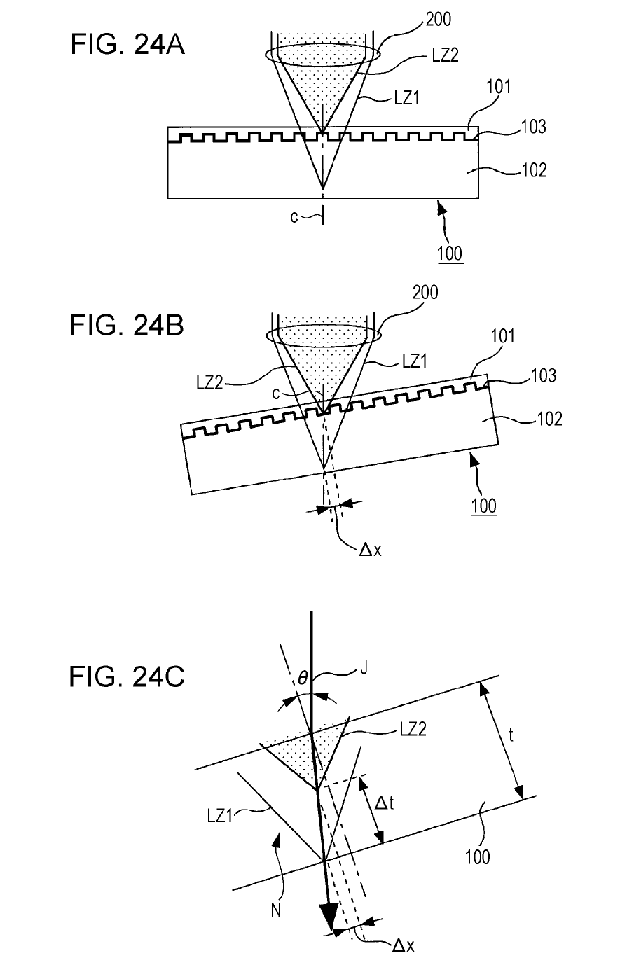

FIGS. 25A to 25C are explanatory diagrams of a spot deviation by eccentricity.

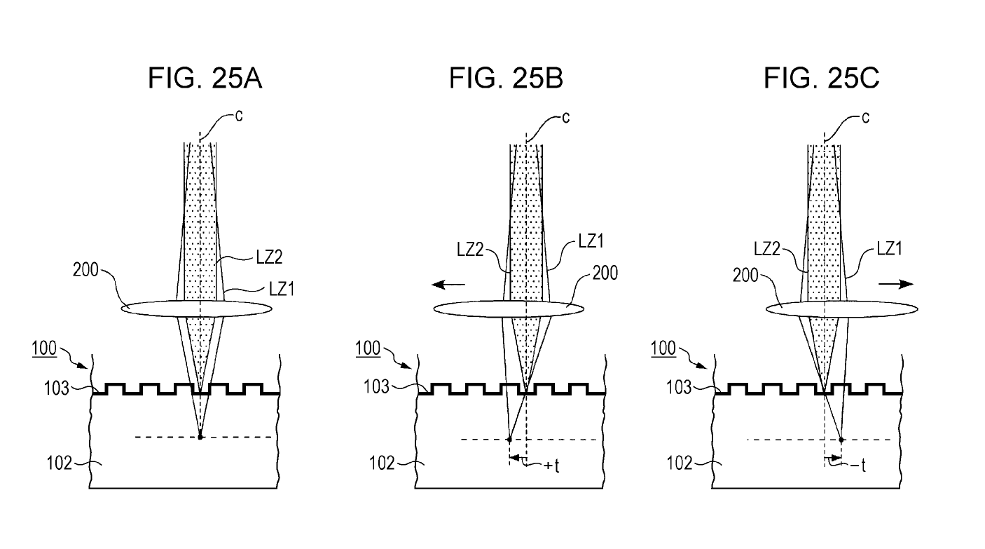

FIG. 26 is an explanatory diagram of the case where a recording track is deviated from an ideal track by a spot deviation.

FIG. 27 is an explanatory diagram of the case where a recording track and a recording track of additional recording overlap by a spot deviation.

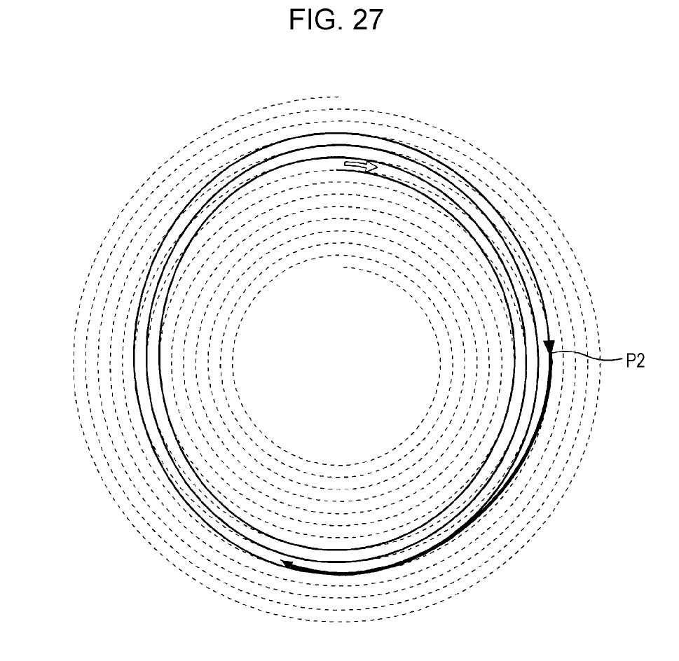

### DETAILED DESCRIPTION

Hereinafter, the example embodiments of the present disclosure will be described in the following order:

[1. Bulk Type Recording Medium];

[2. Configuration of Recording/Reproducing Device];

[3. Recording Process of Embodiment]; and

[4. Tracking Method].

[1. Bulk Type Recording Medium]

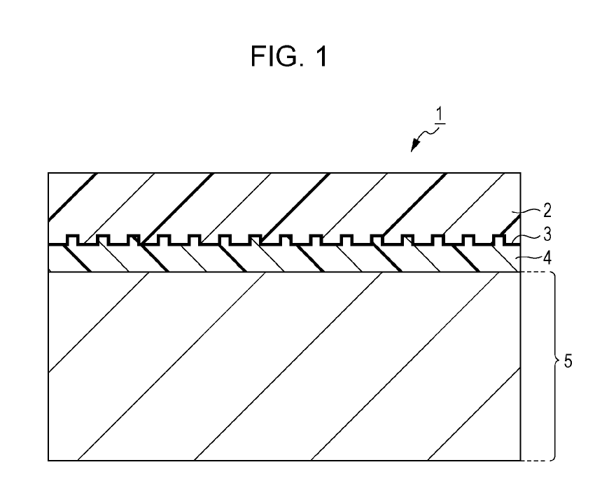

FIG. 1 is a cross-sectional structural diagram of a bulk type optical recording medium (e.g., recording medium 1) of an example embodiment.

As illustrated in FIG. 1, the recording medium 1 is a disc-shaped optical recording medium, and a laser beam is irradiated to the rotated and driven recording medium 1 so as to perform mark recording (information recording). Reproduction of recorded information is performed by irradiating a laser beam to the rotated and driven recording medium 1.

In this example, an optical recording medium used in a negative type micro hologram method or a void recording method is used.

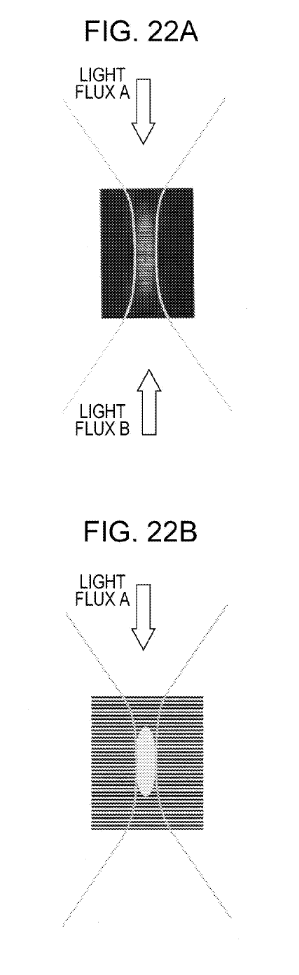

As described in FIGS. 22A and 22B, in the negative type micro hologram method, before performing a recording operation, an initialization process for forming an interference fringe in the bulk layer is performed in advance. After the interference fringe is formed by the initialization process, information recording is performed by forming an erasing mark. Specifically, by irradiating a laser beam according to recording information in a state of focusing on an arbitrary recording layer position, information recording by the erasing mark is performed.

In one example, in the void recording method of a so-called hole (void) as a recording mark, a laser light beam is irradiated to the bulk layer formed of a recording material such as a photopolymerizable photopolymer with relatively high power so as to record a hole (void) in the bulk layer. The formed hole portion has a refractive index different from that of the other portion of the bulk layer and thus the light reflection ratio of the boundary portion thereof is increased. Accordingly, the hole portion functions as the recording mark and thus information recording by formation of a hole mark is realized.

However, the following present example embodiment is not applied to the negative type micro hologram method or the void recording method and is applicable to a certain method of irradiating two systems laser beams, namely, a servo laser beam and a recording laser beam from one surface side of the recording medium 1 to a bulk layer so as to perform information recording.

As illustrated in FIG. 1, the recording medium 1 is a so-called bulk type optical recording medium and, as illustrated, a cover layer 2, a reference surface 3, an intermediate layer 4, and a bulk layer 5 are sequentially formed from an upper layer side (laser incident surface side).

Although the term “thickness direction” or “depth direction” is used in the present specification, the term “thickness direction” or “depth direction” indicates a direction parallel to an incident direction of a laser beam, that is, a thickness direction of the recording medium.

In the recording medium 1, the cover layer 2 is formed of, for example, resin such as polycarbonate or acrylic and, as illustrated, the reference surface 3 is formed on a lower surface side thereof.

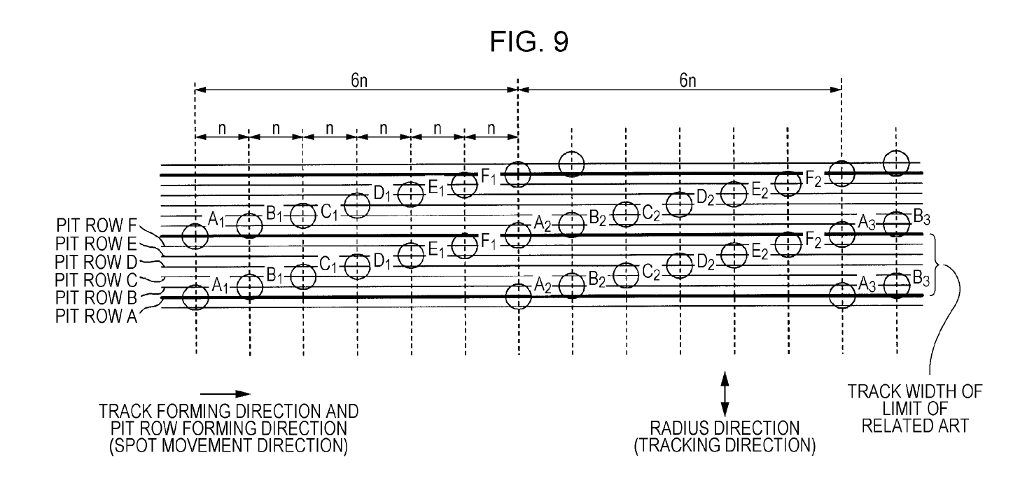

In the reference surface 3, a predetermined pit pattern or an uneven pattern as wobbling grooves for guiding a recording/reproducing position, that is, a tracking position is formed. Although the example of the uneven pattern formed in the reference surface 3 will be described in FIG. 9 or the like, this uneven pattern may guide a tracking position such that a recording track is formed in a spiral shape when being viewed in a display plane direction. The uneven pattern is regarded as a pattern for representing address information.

The cover layer 2 is formed by injection molding or the like using a stamper in which such an uneven shape is formed, and the uneven shape is transferred onto the lower surface side thereof. A selective reflection film is formed on the uneven surface of the cover layer 2 so as to form the reference surface 3.

In a recording method of the recording medium 1, a laser beam (e.g., servo laser beam) for obtaining a tracking or focus error signal based on the reference surface 3 is irradiated separately from a laser beam (e.g., recording/reproducing laser beam) for performing mark recording with respect to the bulk layer 5 as a recording layer.

At this time, if the servo laser beam reaches the bulk layer 5, the mark recording in the bulk layer 5 may be adversely affected. Accordingly, a reflection film having selectivity for reflecting the servo laser beam and transmitting the recording/reproducing laser beam is necessary.

In this example, the recording/reproducing laser beam has a wavelength of 405 nm and the servo laser beam has a wavelength of 660 nm. That is, laser beams with different wavelengths are used.

In correspondence therewith, a selective reflection film having wavelength selectivity, which reflects a light having the same wavelength range as the servo laser beam and transmits a light having the other wavelength range, is used as the selective reflection film.

The bulk layer 5 is formed on the lower layer side (e.g., a rear side when being viewed from the laser incident surface side) of the reference surface 3 with the intermediate layer 4 interposed therebetween as an adhesive layer.

As a material (recording material) forming the bulk layer 5, a material suitable for the recording method such as the negative type micro hologram method or the void recording method may be employed. For example, in the void recording method, a plastic material is employed.

With respect to the bulk layer 5, information recording by mark formation is performed by sequentially focusing the laser beam to each predetermined position in the depth direction of the bulk layer 5.

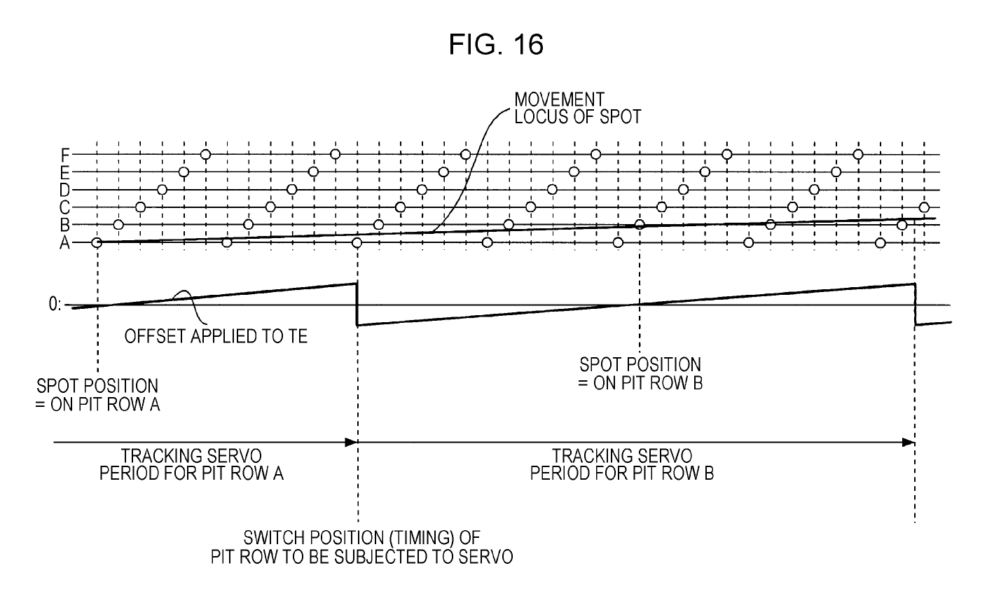

Accordingly, in the recording medium 1 in which recording is completed, a plurality of recording layers is formed in the bulk layer 5 as illustrated in FIG. 16.

Although the thickness, the size and the like of the bulk layer 5 are fixed, for example, when a blue laser beam (wavelength 405 nm) is irradiated by an optical system having a NA of 0.85, a recording layer is preferably formed at a position of 50 μm to 300 μm from the disc front surface (e.g., the front surface of the cover layer 2) in the depth direction. This is a range obtained by considering spherical aberration correction.

In the number of recording layers, it is possible to form a plurality of recording layer when a gap between layers narrows.

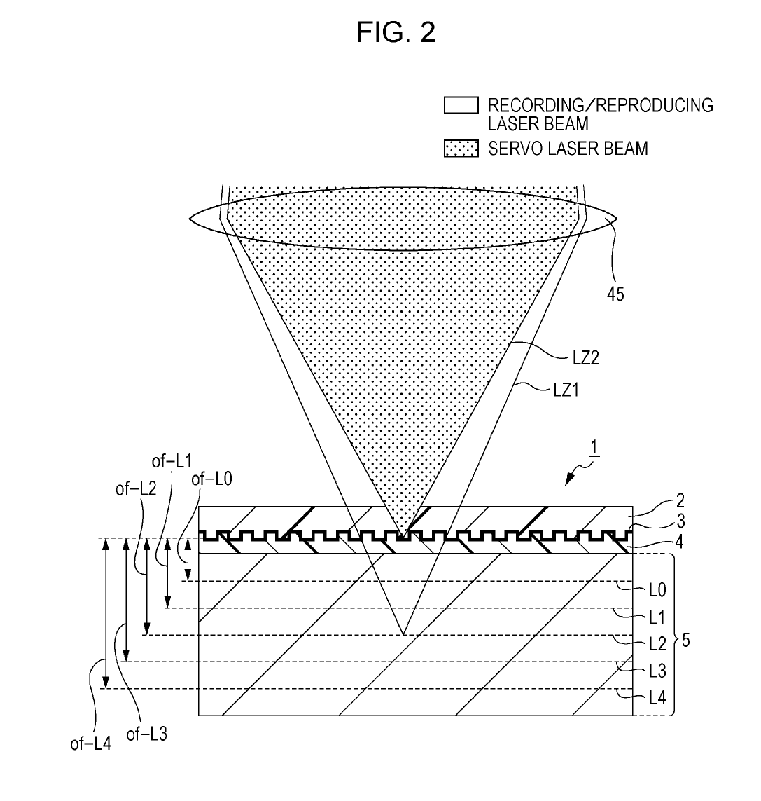

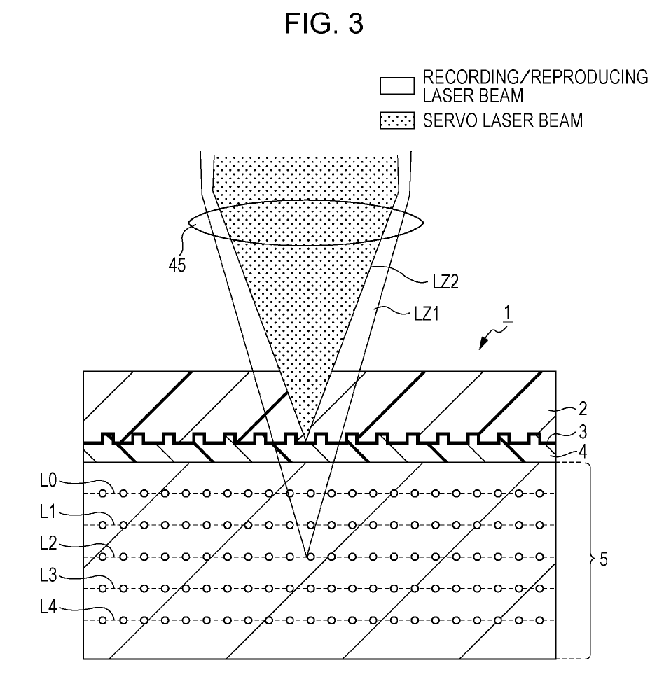

Servo control during recording/reproduction of the recording medium 1 as a target as the bulk type optical recording medium will be described with reference to FIGS. 2 and 3.

As described above, with respect to the recording medium 1, the recording mark is formed, and the recording/reproducing laser beam LZ1 for performing information reproduction and the servo laser beam LZ2 having a wavelength different from that of the recording/reproducing laser beam are irradiated from the recording mark. The recording/reproducing laser beam LZ1 and the servo laser beam LZ2 are irradiated to the recording medium 1 through a common objective lens 45.

As illustrated in FIG. 1, in the bulk layer 5 of the recording medium 1, for example, unlike a multilayer disc for the present optical disc such as a Digital Versatile Disc (DVD) or a Blu-ray Disc (BD), a reflection surface having guide grooves due to pits or grooves is not formed at each layer position to be recorded. Accordingly, during recording in which the mark is not yet formed, focus servo or tracking servo of the recording/reproducing laser beam LZ1 is not performed using the reflected light of the recording/reproducing laser beam LZ1.

To this end, during recording of the recording medium 1, both tracking servo and focus servo of the recording/reproducing laser beam LZ1 are performed using the reflected light of the servo laser beam LZ2.

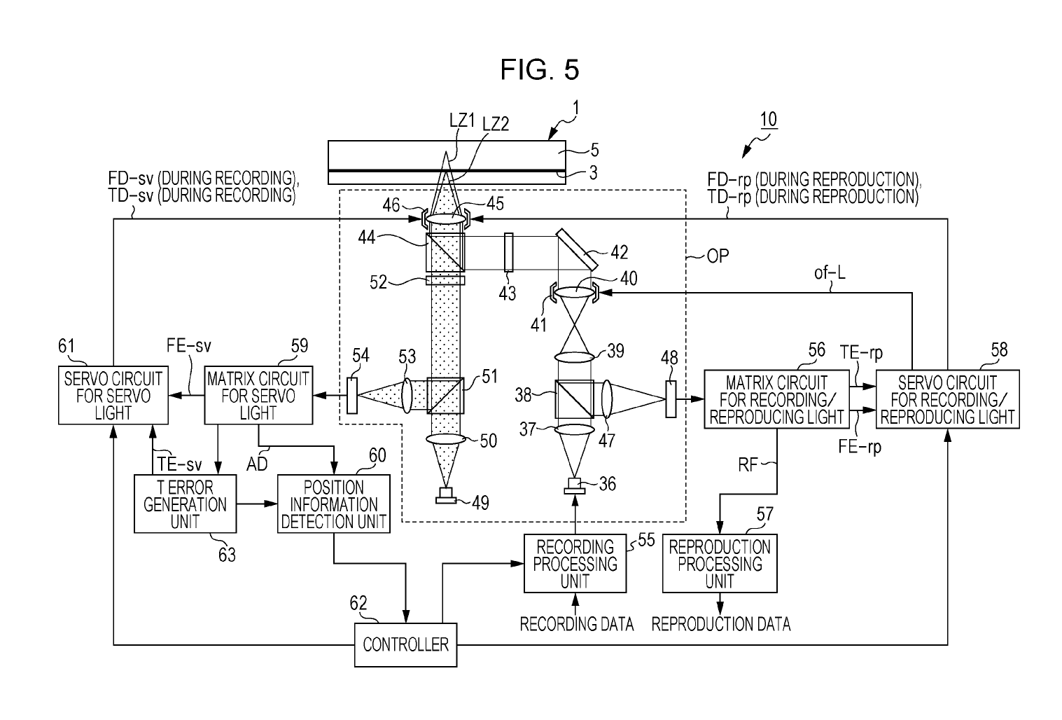

Specifically, in regard to the focus servo of the recording/reproducing laser beam LZ1 during recording, first, a focus mechanism for the recording/reproducing laser beam (an expander of lenses 39 and 40 and a lens driving unit 41 of FIG. 5) for independently changing only the focusing position of the recording/reproducing laser beam LZ1 are provided. In addition, the focus mechanism (expander) for the recording/reproducing laser beam is then controlled based on an offset “of” illustrated in FIG. 2 using the reference surface as a reference.

As described above, the recording/reproducing laser beam LZ1 and the servo laser beam LZ2 are irradiated to the recording medium 1 through the common objective lens 45. The focus servo of the servo laser beam LZ2 is performed by controlling the objective lens 45 using the reflected light (returning light) from the reference surface 3 of the servo laser beam LZ2.

The recording/reproducing laser beam LZ1 and the servo laser beam LZ2 are irradiated through the common objective lens 45 and the focus servo of the servo laser beam LZ2 is performed by the controlling the objective lens 45 based on the reflected light from the reference surface 3 such that the focusing position of the recording/reproducing laser beam LZ1 fundamentally follows the reference surface 3.

In other words, by the focus servo of the objective lens 45 based on the reflected light from the reference surface 3 of the servo laser beam LZ2, the function for enabling the focusing position of the recording/reproducing laser beam LZ1 to follow the surface variation of the recording medium 1 is applied.

Thereafter, using the focus mechanism for the recording/reproducing laser beam LZ1 as described above, the focusing position of the recording/reproducing laser beam LZ1 is offset by the value of the offset “of”. Accordingly, the focusing position of the recording/reproducing laser beam LZ1 follows a necessary depth position in the bulk layer 5.

As illustrated in FIG. 2, the example of the offsets “of” corresponding to the case where information recording layers L0 to L4 are set in the bulk layer 5. That is, FIG. 2 illustrates the case where an offset of-L0 corresponding to the layer position of a recording layer L0, an offset of-L1 corresponding to the layer position of a recording layer L1, . . . , and an offset of-L4 corresponding to the layer position of a recording layer L4 are set. By driving the focus mechanism for the recording/reproducing laser beam LZ1 using the value of the offset “of”, the mark forming position (recording position) in the depth direction may be adequately selected from the layer position as the recording layer L0 to the layer position as the recording layer L4.

In regard to the tracking servo of the recording/reproducing laser beam LZ1 during recording, as described above, the tracking servo of the objective lens 45 using the reflected light of the servo laser beam LZ2 from the reference surface 3 is performed using the point that both the laser beams LZ1 and LZ2 are irradiated through the common objective lens 45. In addition, the address information during recording is acquired from the reflected light information of the servo laser beam LZ2 from the reference surface 3 using the uneven pattern (pit rows or wobbling grooves), in which the address information is recorded, formed in the reference surface 3.

As illustrated in FIG. 3, during reproduction, because the recording layers (e.g., L0 to L4) are formed in the bulk layer 5, it is possible to obtain the reflected light of the recording/reproducing laser beam LZ1 from the recording layers L. Accordingly, during reproduction, the focus servo of the recording/reproducing laser beam LZ1 is performed using the reflected light of the recording/reproducing laser beam LZ1.

That is, the focus servo and the tracking servo of the objective lens 45 may be performed based on the reflected light from the recording layer L of the recording/reproducing laser beam LZ1. The address in the data recorded in the recording mark string may be read.

In this case, during reproduction, the servo laser beam LZ2 may not be used.

Because it is not restricted that recording is completed with respect to the entire region of all the recording layers, even during recording, in order to read the address information recorded in the reference surface 3, the focus servo and the tracking servo of the servo laser beam LZ2 for the reference surface 3 may be performed.

Then, in this case, the focus servo of the recording/reproducing laser beam LZ1 during reproduction may be performed by controlling the focus mechanism for the above-described recording/reproducing laser beam LZ1 based on the reflected light of the recording/reproducing laser beam LZ1. In addition, the tracking servo of the recording/reproducing laser beam LZ1 during reproduction may be realized by performing the tracking servo of the objective lens 45 based on the reflected light of the servo laser beam LZ2.

Actually, in the servo control of the recording/reproducing laser beam LZ1 during reproduction, the above several methods may be employed according to an operation state or usage of the recording device, the recording state of the recording medium, or the like.

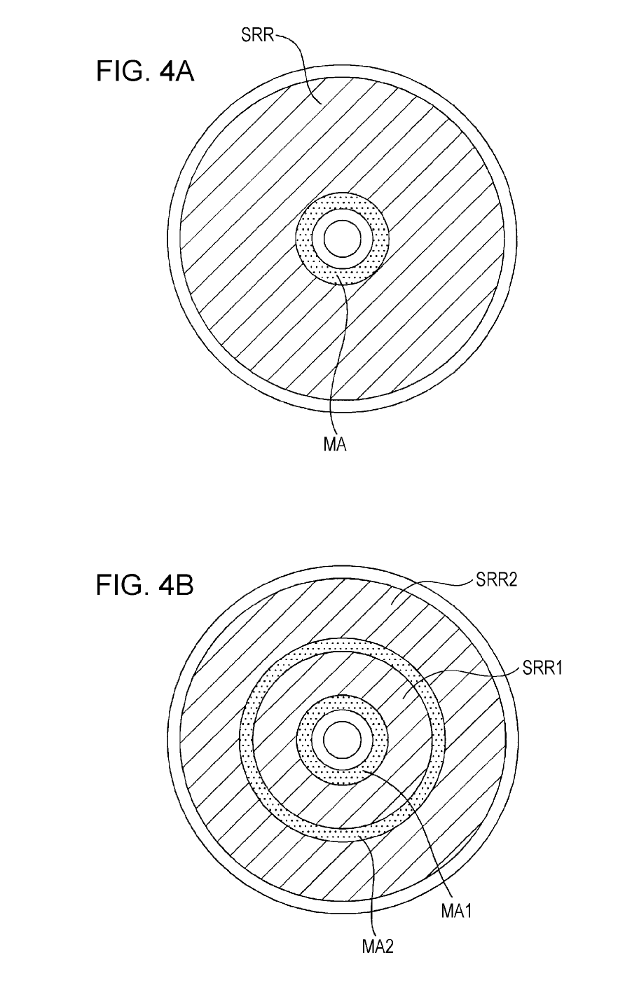

Next, in FIGS. 4A and 4B, a Sequential Recording Range (SRR) of the recording medium 1 will be described. The SRR is an area in which sequential recording of user data is performed in each recording layer L.

FIGS. 4A and 4B are schematic diagrams when the disc-shaped recording medium 1 is viewed in a plane direction, FIG. 4A illustrates the case where one SRR is present. In addition, for example, a management area MA for recording a variety of management information is formed on an inner circumferential side of the SRR. In the management area MA, management information is sequentially recorded using the same method as the recording of the user data in the SRR.

FIG. 4B illustrates the case where two SRRs (SRR1 and SRR2) are formed. A plurality of areas in which sequential recording is performed may be formed. Management areas MA1 and MA2 are formed with respect to SRR1 and SRR2, respectively.

For example, if a plurality of recording/reproducing heads is used in order to improve the performance of the recording/reproducing device, it is possible to efficiently perform recording/reproduction using the plurality of heads, by using a plurality of SRRs.

Three or more SRRs may be set.

[2. Configuration of Recording/Reproducing Device]

The configuration of the recording/reproducing device 10 of the embodiment for performing recording/reproduction with respect to the above-described recording medium 1 will be described with reference to FIG. 5.

In the recording/reproducing device 10, an optical pickup OP for irradiating the recording/reproducing laser beam LZ1 and the servo laser beam LZ2 to the bulk type recording medium 1 rotated and driven by a spindle motor is provided.

In the optical pickup OP, a recording/reproducing laser diode 36 which is a light source of the recording/reproducing laser beam LZ1 and a servo laser diode 49 which is a light source of the servo laser beam LZ2 are provided.

As described above, the recording/reproducing laser beam LZ1 and the servo laser beam LZ2 have different wavelengths, respectively. In this example, the wavelength of the recording/reproducing laser beam LZ1 is about 405 nm (so-called violet laser beam) and the wavelength of the servo laser beam LZ2 is about 650 nm (red laser beam).

In the optical pickup OP, the objective lens 45 which is an output terminal of the recording/reproducing laser beam LZ1 and the servo laser beam LZ2 to the recording medium 1 is provided.

In addition, a light-sensing portion 48 for the recording/reproducing light, which senses the reflected light from the recording medium 1 of the recording/reproducing laser beam LZ1, and a light-sensing portion 54 for the servo light, which senses the reflected light from the recording medium 1 of the servo laser beam LZ2, are provided.

In the optical pickup OP, an optical system for guiding the recording/reproducing laser beam LZ1 irradiated from the recording/reproducing laser diode 36 to the objective lens 45 and guiding the reflected light of the recording/reproducing laser beam LZ1 from the recording medium 1 incident to the objective lens 45 to the light-sensing portion 48 for the recording/reproducing light is formed.

Specifically, the recording/reproducing laser beam LZ1 irradiated from the recording/reproducing laser diode 36 becomes a parallel light through a collimation lens 37 so as to enter the polarization beam splitter 38. The polarization beam splitter 38 is configured to transmit the recording/reproducing laser beam LZ1 incident from the recording/reproducing laser diode 36 side.

The recording/reproducing laser beam LZ1 transmitting through the polarization beam splitter 38 enters an expander including a fixed lens 39, a movable lens 40, and a lens driving unit 41. In this expander, the fixed lens 39 is located close to the recording/reproducing laser diode 36 which is the light source and the movable lens 40 is located far from the recording/reproducing laser beam 36. By driving the movable lens 40 by the lens driving unit 41 in a direction parallel to an optical axis of the recording/reproducing laser beam LZ1, independent focus control is performed with respect to the recording/reproducing laser beam LZ1.

With respect to the focus mechanism for the recording/reproducing light (e.g., lens driving unit 41), during recording, a servo circuit 58 for the recording/reproducing light is driven by an instruction of a controller 62 according to the value (see e.g., FIG. 2) of the offset of-L corresponding to the position of information recording layer L to be recorded.

The recording/reproducing laser beam LZ1 passing through the focus mechanism for the recording/reproducing light is reflected from a mirror 42 and then enters into a dichroic prism 44 through a ¼ wavelength plate 43.

The dichroic prism 44 is configured so as to reflect a light with the same wavelength range as the recording/reproducing laser beam LZ1 and transmit a light with the other wavelength range. Accordingly, as described above, the incident recording/reproducing laser beam LZ1 is reflected from the dichroic prism 44.

The recording/reproducing laser beam LZ1 reflected from the dichroic prism 44 is irradiated onto the recording medium 1 through the objective lens 45, as illustrated.

In the objective lens 45, a biaxial mechanism 46 for displaceably holding the objective lens 45 in the focus and the tracking direction is provided.

The biaxial mechanism 46 includes a focus coil and a tracking coil and displaces the objective lens 45 in the focus direction and the tracking direction by respectively applying driving signals (e.g., the below-described driving signals FD and TD) to the focus coil and the tracking coil, respectively.

During reproduction, by irradiating the recording/reproducing laser beam LZ1 to the recording medium 1 as described above, the reflected light of the recording/reproducing laser beam LZ1 is obtained from the recording medium 1 (the mark string recorded in the information recording layer L to be reproduced in the bulk layer 5).

The reflected light of the recording/reproducing laser beam LZ1 obtained by the above operation is guided to the dichroic prism 44 through the objective lens 45 and is reflected from the dichroic prism 44.

The reflected light of the recording/reproducing laser beam LZ1 reflected from the dichroic prism 44 passes through the ¼ wavelength plate 43, the mirror 42 and the focus mechanism for the recording/reproducing light (the movable lens 40 and the fixed lens 39) and then enters into the polarization beam splitter 38.

The polarization direction of the reflected light (returning light) of the recording/reproducing laser beam LZ1 incident to the polarization beam splitter 38 is different from that of the recording/reproducing laser beam LZ1 (forward light) incident from the recording/reproducing laser diode 36 side to the polarization beam splitter 38 by 90°, by the operation by the ¼ wavelength plate 43 and the reflection operation of the recording medium 1. As a result, the reflected light of the incident recording/reproducing laser beam LZ1 is reflected from the polarization beam splitter 38.

The reflected light of the recording/reproducing laser beam LZ1 reflected from the polarization beam splitter 38 is focused on the light-sensing surface of the light-sensing portion 48 for the recording/reproducing light through the focusing lens 47.

In the optical pickup OP2, in addition to the above-described configuration of the optical system for the recording/reproducing laser beam LZ1, an optical system for the servo laser beam LZ2 is formed. That is, an optical system for guiding the servo laser beam LZ2 irradiated from the servo laser diode 49 to the objective lens 45 and guiding the reflected light of the servo laser beam LZ2 from the recording medium 1 incident to the objective lens 45 to the light-sensing portion 54 for the servo light is formed.

As illustrated, the servo laser beam LZ2 irradiated from the servo laser diode 49 becomes a parallel light through a collimation lens 50 and then enters into a polarization beam splitter 51. The polarization beam splitter 51 is configured so as to transmit the servo laser beam (forward light) incident from the servo laser diode 49 side.

The servo laser beam LZ2 transmitting through the polarization beam splitter 51 enters into the dichroic prism 44 through a ¼ wavelength plate 52.

As described above, the dichroic prism 44 is configured so as to reflect a light with the same wavelength range as the recording/reproducing laser beam LZ1 and transmit a light with the other wavelength range. Accordingly, the servo laser beam LZ2 transmits through the dichroic prism 44 so as to be irradiated to the recording medium 1 through the objective lens 45.

The reflected light (e.g., the reflected light from the reference surface 3) obtained by irradiating the servo laser beam LZ2 to the recording medium 1 passes through the objective lens 45, transmits the dichroic prism 44 and enters into the polarization beam splitter 51 through the ¼ wavelength plate 52.

The polarization direction of the reflected light (returning light) of the servo laser beam LZ2 incident from the recording medium 1 side is different from that of the forward light by 90°, by the operation of the ¼ wavelength plate 52 and the reflection operation of the recording medium 1. Thus, the reflected light of the servo laser beam LZ2 as the returning light is reflected from the polarization beam splitter 51.

Thus, the reflected light of the servo laser beam LZ2 reflected from the polarization beam splitter 51 is focused on the light-sensing surface of the light-sensing portion 54 for the servo light through the focusing lens 53.

Although the description is omitted, practically, in the recording/reproducing device 10, a slide mechanism for sliding and driving the overall above-described optical pickup OP in the tracking direction is provided so as to widely displace the irradiation position of the laser beam by the driving of the optical pickup OP by the slide mechanism.

In the recording/reproducing device 10, a recording processing unit 55, a matrix circuit 56 for a recording/reproducing light, a reproduction processing unit 57, a servo circuit 58 for a recording/reproducing light, a matrix circuit 59 for a servo light, a position information detection unit 60, a servo circuit 61 for a servo light, a controller 62, and a tracking error generation unit 63 are provided.

First, data to be recorded (recording data) with respect to the recording medium 1 is input to the recording processing unit 55. The recording processing unit 55 performs addition of an error correction code or predetermined recording modulation encoding with respect to the input recording data or the like and obtains a recording modulation data string which is a binary data string of “0” and “1”, for example, actually recorded in the recording medium 1.

A write strategy is performed based on the recording modulation data string, and a laser driving signal is generated. The laser driving signal is applied to the recording/reproducing laser diode 36 so as to perform emission drive of the recording/reproducing laser diode 36.

The recording processing unit 40 performs such a process according to an instruction from the controller 62.

The matrix circuit 56 for the recording/reproducing light includes a current/voltage conversion circuit, a matrix calculation/amplification circuit, and the like in correspondence with a plurality of light-sensing elements as the above-described light-sensing portion 48 for the recording/reproducing light, and generates necessary signals by a matrix calculation process.

Specifically, a radio-frequency signal (referred to as a reproduction signal RF) corresponding to a reproduction signal reproducing the above-described recording modulation data string, a focus error signal FE-rp for focus servo control and a tracking error signal TE-rp for tracking servo control are generated.

The reproduction signal RF generated by the matrix circuit 56 for the recording/reproducing light is supplied to the reproduction processing unit 57.

The reproduction signal processing unit 57 performs a reproduction process for restoring the above-described recording data, such as a binarization process, a process of decoding the recording modulation code, or an error correction process, with respect to the reproduction signal RF and obtains the reproduction data reproducing the recording data.

The focus error signal FE-rp and the tracking error signal TE-rp obtained by the matrix circuit 56 for the recording/reproducing light are supplied to the servo circuit 58 for the recording/reproducing light.

The servo circuit 58 for the recording/reproducing light generates a focus drive signal FD-rp and a tracking drive signal TD-rp based on the focus error signal FE-rp and the tracking error signal TE-rp. During reproduction, the focus drive signal FD-rp and the tracking drive signal TD-rp are supplied to the focus coil and the tracking coil of the biaxial actuator 46 so as to perform focus servo control and tracking servo control of the recording/reproducing laser beam LZ1.

In addition, the servo circuit 58 for the recording/reproducing light generates a focus servo signal based on the focus error signal FE-rp and drives and controls the lens driving unit 41 based on the focus servo signal, thereby performing focus servo control of the recording/reproducing laser beam LZ1.

The servo circuit 58 for the recording/reproducing light drives the lens driving unit 41 based on a predetermined offset “of” (see e.g., FIG. 2) according to an instruction from the controller 62.

In addition, the servo circuit 58 for the recording/reproducing light turns off a tracking servo loop according to the instruction from the controller 62 during reproduction and applies a jump pulse to the tracking coil so as to execute a track jump operation or perform tracking servo pull-in control or the like. In addition, focus servo pull-in control or the like is performed.

On the other hand, in regard to the servo laser beam LZ2 side, the matrix circuit 59 for the servo light generates a focus error signal FE-sv based on the light-sensing signals from the plurality of light-sensing elements of the light-sensing portion 54 for the servo light.

The matrix circuit 59 for the servo light generates the below-described sum signal, push-pull signal PP, or the like and supplies the signals to the tracking error generation unit 63.

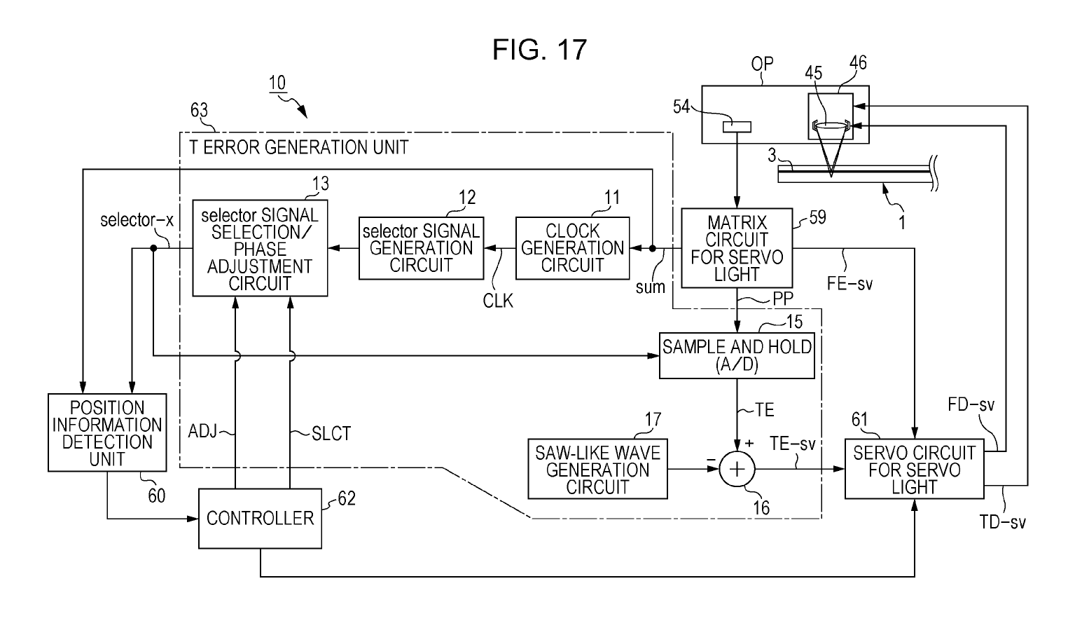

The tracking error generation unit 63 generates a tracking error signal TE-sv which is subjected to variable track pitch control according to the below-described pit pattern of the reference surface 3. The tracking error generation unit 63 will be described in detail later with reference to FIG. 17.

The focus error signal FE-sv and the tracking error signal TE-sv are supplied to the servo circuit 61 for the servo light.

In addition, the matrix circuit 59 for the servo light generates a signal AD corresponding to address information as reproduction information of the pit pattern of the reference surface 3 and supplies the signal to the position information detection unit 60.

The position information detection unit 60 performs a process of decoding the signal AD and detects absolute position information (address information) recorded in the pit row of the reference surface 3. The detected absolute position information is supplied to the controller 62.

The servo circuit 61 for the servo light generates a focus drive signal FD-sv and a tracking drive signal TD-sv based on the focus error signal FE-sv and the tracking error signal TE-sv. The focus drive signal FD-sv and the tracking drive signal TD-sv are supplied to drive the focus coil and the tracking coil of the biaxial actuator 46 so as to perform focus servo control and the tracking servo control of the servo laser beam.

The focus servo control and the tracking servo control of the servo laser beam by the servo circuit 61 for the servo light is mainly performed during recording.

In addition, the servo circuit 61 for the servo light turns off the tracking servo loop according to the instruction from the controller 62 during recording and applies a jump pulse to the tracking coil of the biaxial actuator 46 so as to execute a track jump operation or perform tracking servo pull-in control or the like. In addition, focus servo pull-in control or the like is performed.

The controller 62 includes a micro computer including, for example, a Central Processing Unit (CPU) or a memory (storage device) such as a Read Only Memory (ROM), and executes a process according to a program stored in the ROM or the like. Control signals are applied to the respective units so as to perform the overall control of the recording/reproducing device 10.

More specifically, the controller 62 performs the control (the selection of the recording position in the depth direction) of the focusing position of the recording/reproducing laser beam LZ1 based on the value of the offset “of” set in correspondence with each layer position in advance as described with reference to FIG. 2, during recording. That is, the controller 62 instructs the servo circuit 58 for the recording/reproducing light to drive the lens driving unit 41 based on the value of the offset “of” set in correspondence with the layer position to be recorded so as to perform the selection of the recording position in the depth direction.

The tracking servo control during recording is performed based on the reflected light of the servo laser beam LZ2. Accordingly, the controller 62 instructs the servo circuit 61 for the servo light to execute the tracking servo control based on the tracking error signal TE-sv, during recording.

In addition, during recording, the controller 62 instructs the servo circuit 61 for the servo light to execute the focus servo control (e.g., the focus servo control of the objective lens 45) based on the focus error signal FE-sv.

During reproduction, the controller 62 instructs the servo circuit 58 for the recording/reproducing light to execute the focus servo control and the tracking servo control of the objective lens 45.

As described above, even during reproduction, the servo control by the servo laser beam LZ2 may be performed. However, in the present embodiment, in particular, in regard to tracking control, when at least the below-described recording track corresponding to additional recording and recording track during the start of additional recording is traced, tracking control using the recording/reproducing laser beam LZ1 is suitable.

[3. Recording Process of Embodiment]

A recording process of an embodiment will be described. In the present embodiment, as described above, with respect to the bulk type recording medium 1, recording is performed using the recording/reproducing laser beam LZ1 and the servo laser beam LZ2. The point of the recording operation will be described in the following (PT1) to (PT3).

(PT1) In the recording medium 1, data is sequentially (consecutively) recorded in the above-described SRR. In this case, during a general recording operation, a recording track (e.g., a first recording track) is formed with a fixed track pitch. In addition, the general recording operation means that recording continues in a state in which the recording medium 1 is not replaced. At predetermined timing such as the case where the recording medium 1 is ejected after sequential recording, a recording track (e.g., a second track) corresponding to additional recording is formed by a recording operation using variable track pitch control.

(PT2) If additional tracking is performed with respect to the recording medium 1 in which the recording track corresponding to additional recording is formed, additional recording (e.g., a third track and a fourth track) is started from an end of the recording track corresponding to additional recording. At this time, the recording track during the start of additional recording is formed by the recording operation using the variable track pitch control. In addition, subsequently to the recording track during the start of additional recording, general recording at a fixed track pitch proceeds.

(PT3) During general recording start or during restart of paused recording, recording of actual user data is performed after running recording track is formed.

Hereinafter, the detailed description will be given.

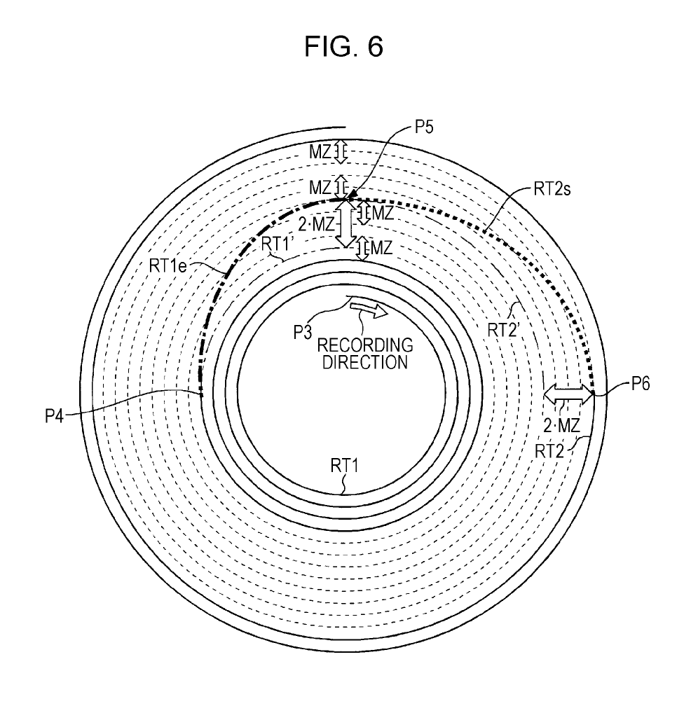

FIG. 6 is a schematic diagram showing the recording track on the recording medium 1.

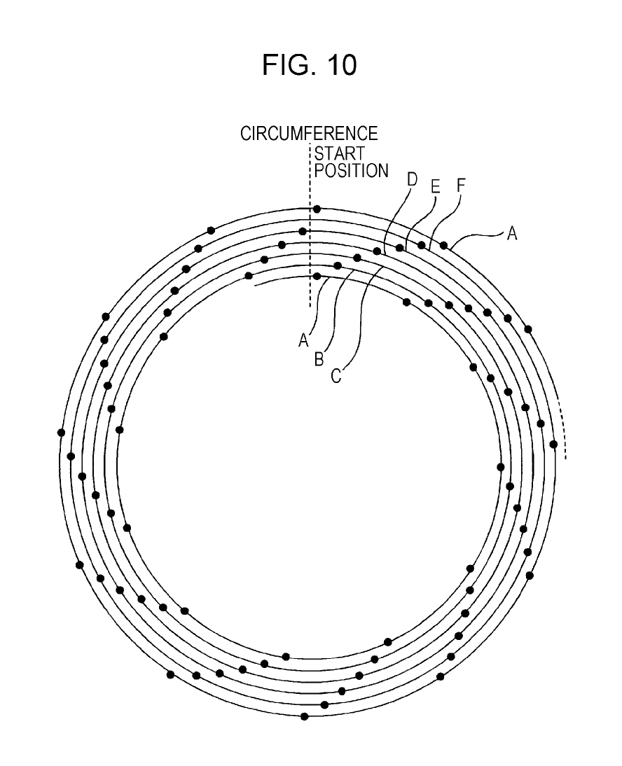

A broken line of FIG. 6 denotes an ideal track defined by pit rows of the reference surface 3. Although described in detail later, in the present embodiment, in the reference surface 3 of the recording medium 1, as described in FIGS. 9 and 10 and the like, a pit row for the variable track pitch control is formed. The ideal track described in FIG. 6 is not a track of the pit rows itself of FIG. 10, but is an ideal recording track of a predetermined track pitch controlled by pit rows A to F of FIG. 10.

In addition, a recording track formed by a recording operation of user data or the like is denoted by a solid line.

In addition, the spot positions of the servo laser beam LZ2 and the recording/reproducing laser beam LZ1 are deviated in the tracking direction according to the visual field swing or the tilt state due to eccentricity such that the actual recording track is deviated from the ideal track, as described above.

Although the recording tracks RT1 and RT2 formed by sequential recording are illustrated in FIG. 6, for description, the recording tracks RT1 and RT2 are illustrated as being matched to the ideal track.

In FIG. 6, a thick dashed dotted line denotes the recording track RT1e corresponding to additional recording. In addition, a thick dotted line denotes the recording track RT2s during the start of additional recording.

First, the above points (PT1) and (PT2) will be described using FIG. 6.

The recording track RT1 is a recording track formed by sequentially recording user data with a fixed track pitch.

Now, it is assumed that the recording track RT1 is formed as the recording operation of the user data from the position P3 to the position P4 of the inner circumferential side. The track pitch is fixed, that is, an ideal track is maintained.

For example, it is assumed that the recording medium 1 is ejected from the recording/reproducing device 10. At this time, the recording/reproducing device 10 forms the recording track RT1e corresponding to additional recording as illustrated. The recording track RT1e corresponding to the additional recording considers disabling the recording track during additional recording thereafter to overlap with the recorded track.

The recording track RT1e corresponding to additional recording is formed, for example, in a predetermined distance range subsequently to the sequentially recorded recording track RT1. In this example, the track is formed in a ¼ circumferential section from the position P4 of the end of the recording track RT1 to a position P5.

The recording track RT1e corresponding to additional recording is gradually enlarged until the separation distance (e.g., a first separation distance) of the track pitch direction with the recording track RT1 which is already recorded becomes a separation distance exceeding a distance corresponding to twice a number of maximum deviation tracks in the ¼ circumferential section.

The number of maximum deviation tracks is denoted by “MZ”.

The maximum deviation track number MZ indicates a maximum deviation amount of the recording track and the ideal track as a track number by a deviation in track pitch direction between the focusing position of the recording/reproducing laser beam LZ1 and the focusing position of the servo laser beam LZ2.

The maximum deviation track number MZ is determined using the deviation amount in the track pitch direction between the focusing position of the recording/reproducing laser beam LZ1 and the servo laser beam LZ2 due to at least a tilt state between the recording medium 1 and the optical pickup OP and an eccentric state of the recording medium 1. In addition, errors due to adjustment precision (misalignment) of an optical system, a change with time, or expansion and contraction by a temperature or the like are preferably considered.

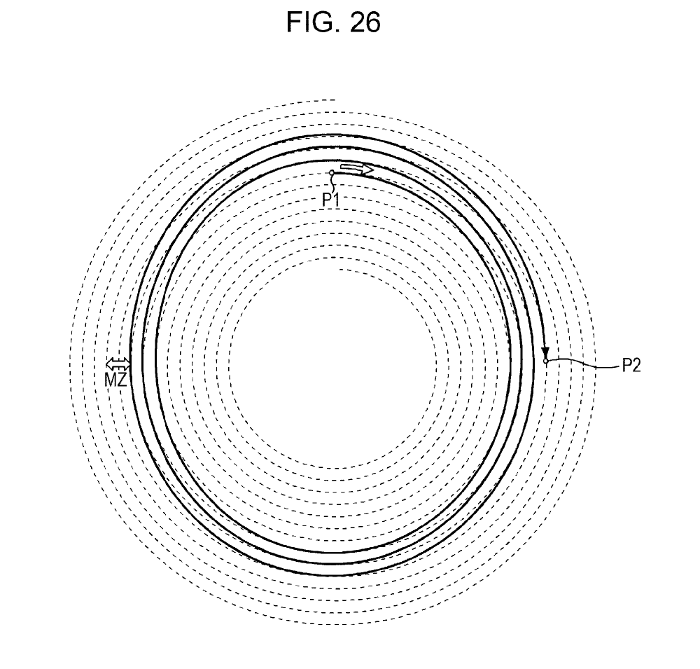

In the deviation of the recording track illustrated in FIG. 26, it is assumed that a maximum deviation amount is generated. In FIG. 26, the recording track is deviated by two tracks from the ideal track. In this case, the maximum deviation track number MZ=2 tracks.

If the tracks are separated by four tracks twice the maximum deviation track number MZ=2 tracks, in the worst case, the overlapping of the recording track does not occur.

For example, it is assumed that, during recording of the recording track RT1, a maximum spot deviation occurs in an outer circumferential direction and a deviation of 2 tracks occurs. Next, it is assumed that, when additional recording is performed, during recording, a maximum spot deviation occurs in an inner circumferential direction and a deviation of 2 tracks occurs. Even in this case, if the start position of the recording track during additional recording is separated from initial recording track by 4 tracks in the track pitch direction, overlapping of the recording tracks before and after additional recording does not occur. That is, the recorded recording track RT1 is not destroyed.

For the protection of the recording track RT1, the recording track RT1e corresponding to additional recording is formed such that the recording start position during subsequent additional recording is deviated to the outer circumferential side.

Accordingly, the recording track RT1e corresponding to additional recording is gradually enlarged until the separation distance of the track pitch direction with the recording track RT1 becomes a separation distance exceeding a distance corresponding to twice the maximum deviation track number.

Even in the case of FIG. 6, the maximum deviation track number MZ is series of 2 tracks. Then, the recording track RT1e corresponding to additional recording is gradually enlarged until the separation distance of the track pitch direction with the recording track RT1 becomes a separation distance of 4 or more tracks in the ¼ circumferential section.

If recording of the ¼ circumferential section is performed from the position P4 with a fixed track pitch, a track RT1′ denoted by a dashed-two dotted line is obtained. With respect to the track RT1′, when viewed at the circumference position of the position P5, the recording track RT1e corresponding to additional recording is separated by 4 tracks (twice MZ). As a result, at the position P4, when viewed from the recorded track RT1, the end of the recording track RT1e corresponding to additional recording is separated by 2·MZ or more.

At the end portion of the sequential recording at the fixed track pitch, the operation for recording the recording track RT1e corresponding to additional recording becomes the operation of the above point (PT1).

In addition, dummy data is recorded in the recording track RT1e corresponding to additional recording. If it is known that the eject is performed after the recording of the recording track RT1 by sequential recording is completed, the end portion of the actual user data recording may be recorded as the recording track RT1e corresponding to additional recording.

In order to form the recording track RT1e corresponding to additional recording, variable track pitch control is necessary as tracking servo control. That is, it is necessary to execute a trace so as to straddle the ideal track the outer circumferential side. A tracking method therefore will be described in detail later.

Next, additional recording after recording to the position P5 is performed will be described.

For example, after the recording track RT1e corresponding to additional recording is formed, the recording medium 1 is ejected and is loaded into the recording/reproducing device 10 (or another recording/reproducing device 10) again and additional recording is performed.

As described above, the tilt state or the eccentric state (chucking state) is changed according to the individual recording/reproducing device 10 and is changed whenever the recoding medium 1 is loaded even in the same recording/reproducing device 10. Accordingly, during additional recording, the same “deviation” state as during recording of the recording track RT1 up to that does not occur.

Because the end of the recording track RT1e corresponding to additional recording formed before eject has a separation distance twice or more of the maximum deviation track number MZ, even in the worse case, the recording track formed by additional recording from the position P5 does not overlap or cross the recording track RT1.

However, if the deviation state is worst, the additionally recorded track may overlap or cross the recording track RT1e corresponding to additional recording. Then, additionally recorded user data may not be correctly recorded.

If additional recording is performed from the end of the recording track RT1e corresponding to additional recording, first, a recording track RT2s during the start of additional recording is formed.

That is, if additional recording of information is performed with respect to the recording medium 1 in which the recording track RT1e corresponding to additional recording is formed, the recording track RT2s during the start of additional recording is consecutively formed from the end (position P5) of the recording track RT1e corresponding to additional recording as illustrated in the drawing. The recording track RT2s during the start of additional recording is gradually enlarged until the separation distance of the track pitch direction with the recorded recording track RT1e corresponding to additional recording becomes a separation distance of a distance corresponding to twice the maximum deviation track number MA.

The recording track RT2s during the start of additional recording is formed in a ¼ circumference section of the positions P5 to P6.

If general recording which follows the ideal track is performed from the position P5, a track RT2′ is obtained, and the recording track RT2s during the start of additional recording has a separation distance of MZ·2 or more from this track RT2′ at the position P6.

Even when the recording track RT2s during the start of additional recording is formed, the below-described variable track pitch control is performed as tracking servo control.

As the additional recording operation, if the ¼ circumferential section has passed from start, general recording with the fixed track pitch is performed. That is, from the position P6, by the fixed track pitch control based on the ideal track, recording of user data or the like is performed so as to form the recording track RT2 as illustrated in the drawing.

If the recording track RT2 is formed by the fixed track pitch control, the recording track RT2 is maintained at a separation distance of 2·MZ or more in the radius direction from the end (position P5) of the recording track RT1e corresponding to additional recording of a previous recording end time point.

The recording device states or various recording conditions are different with respect to the position P5 as a boundary, even at the position P5, the recording track RT2 is separated by 2·MZ or more in the radius direction and, as a result, the overlapping or crossing of the recording tracks before and after eject does not occur, regardless of a change in the spot deviation state during additional recording.

The recording of the recording track RT2s during the start of additional recording and the subsequent recording of the recording track RT2 with the fixed track pitch become the operation of the above point (PT2).

In addition, additional recording is started from the recording track RT2s during the start of additional recording, but, when the recording track RT2s during the start of additional recording is formed, for example, actual data recording of user data or the like may be performed. That is, actual data additional recording is started from the recording track RT2s during the start of additional recording.

For example, dummy data is recorded only in the recording track RT2s during the start of additional recording of the ¼ circumference section, actual data recording is performed as the recording of the recording track RT2s with the fixed track pitch from the position P6.

By performing the operations of the above points (PT1) and (PT2), overlapping or crossing of the tracks does not occur even when the spot deviation state is changed before and after eject or the like. Accordingly, the already recorded data and the additionally recorded data are not destroyed and recording and reproducing reliability is improved.

By solving the overlapping of the tracks due to the sport deviation as handling before and after additional recording, it is unnecessary to widen the track pitch. That is, in regard to the track pitch during general recording, the overlapping of the tracks may not be considered. Because the slope of the recording medium 1 and the visual field deviation of the objective lens 45 or the like are not changed during recording, the influence thereof is not considered.

This means that the “track pitch” when sequential recording with the fixed track pitch is performed may narrow.

By narrowing the track pitch, it is possible to prompt large capacity.

In addition, although the recording track RT1e corresponding to additional recording and the recording track RT2s during the start of additional recording are formed in the ¼ circumferential section respectively, this is exemplary. For example, ½ circumferential section, one circumferential section, or the like may be used. This section length is set to an appropriate distance according to the variable track pitch control state so as to be deviated to the outer circumferential side or the setting of the maximum deviation track number or the like.

In addition, the recording track RT1 before additional recording and the recording track RT2 by additional recording become consecutive through the recording track RT1e corresponding to additional recording and the recording track RT2s during the start of additional recording. Accordingly, during reproduction, it is possible to follow the recording track as tracking control by the recording/reproducing laser beam LZ1.

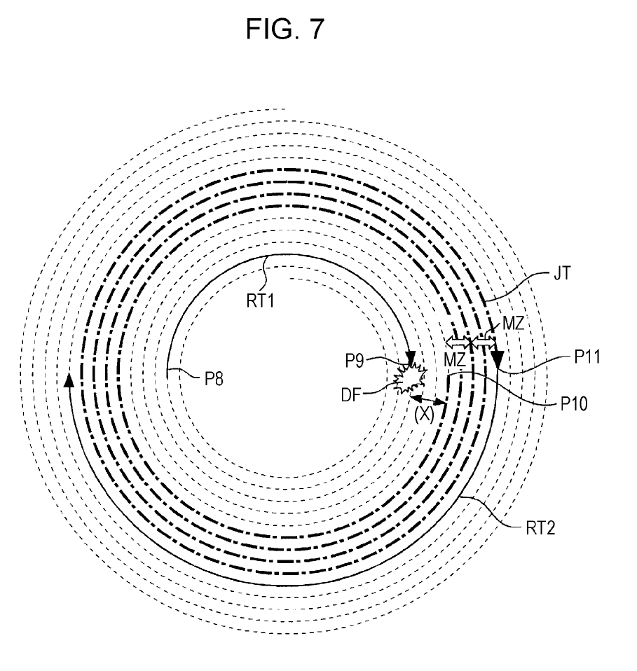

Next, the point (PT3) will be described with reference to FIG. 7.

Even in FIG. 7, an ideal track is denoted by a broken line and actual recording tracks RT1 and RT2 are denoted by a solid line. In addition, a dashed dotted line denotes a running recording track JT. It is assumed that the recording tracks RT1 and RT2 are not deviated from the ideal track.

FIG. 7 illustrates the case where recording is stopped by a defect DF on the recording medium 1 during recording of the recording track RT1. It is assumed that, when recording of user data or the like from a position P8 is performed so as to form the recording track RT1, recording is stopped by the defect DF at a position P9.

Thereafter, it is assumed that data is continuously recorded or another data is recorded such that recording of the recording medium 1 is restarted.

In this case, recording is restarted from a certain position P10 (near the position where recording is stopped) avoiding the defect DF.

The position P10 is separated from the stop position P9 due to the defect DF by an appropriate separation distance X (e.g., a second separation distance). This separation distance X is set to an appropriate distance, but is set to, for example, twice the maximum deviation track number+α(radius-direction distance exceeding twice the maximum deviation track number).

In the restart of the recording from the position P10, first, the running recording track JT is formed. The running recording track JT is formed by recording dummy data.

The recording of the running recording track JT continues up to a position P11 with a fixed track pitch. The formation range of the running recording track JT is a radius-direction distance exceeding a distance corresponding to twice the maximum deviation track number MAZ in the radius direction.

Consecutively to the running recording track JT, data to be actually recorded is recorded and the recording track RT2 is formed.

By the above operation, even when a spot deviation occurs in a worst state, the recording track RT2 after restart does not overlap the part of the defect DF. In addition, the recording track RT1 before stoppage and the recording track RT2 after restart do not overlap each other.

Such an operation becomes a detailed example of the point (PT3).

The operation for recording the running recording track JT is not limited the case where stoppage occurs by the defect DF.

For example, even when an impact is applied as disturbance or detrack occurs due to the other situations such that recording is stopped, the recording restart operation for forming the same running recording track JT is performed.

In addition, after the recording/reproducing device 10 is powered on or after the recording medium 1 is loaded, even when recording is initially performed and the above-described recording track RT1e corresponding to additional recording is not present, the recording start operation for forming the running recording track JT is performed during recording start.

By this operation, if a defect or a certain abnormal operation is present, it is possible to eliminate adverse influence by the spot deviation.

By forming the running recording track JT even during recording start, it is possible to protect data of an area before a start position with certainty. For example, in the case where additional recording is performed with respect to the recording medium 1 recorded by the recording/reproducing device which does not form the above-described recording track RT1e corresponding to additional recording, past data is not destroyed. In addition, when recording is initially performed with respect to the non-recorded recording medium 1 from the beginning of the SRR, it is possible to protect the information of an adjacent management information area MA.

In addition, if the running recording track JT is formed, a pair of an address obtained from the reference surface 3 substantially at a central position of the section in which the running recording track JT is formed and a start address (logical address recorded in user data) of user data is recorded in the management area MA.

During reproduction, using this information, access to the inside of the running recording track JT is performed and reproduction spot scanning of the recording/reproducing laser beam LZ1 reaches a start position P11 of the recording track RT2 in which user data is recorded.

That is, if the width of the radius direction in which the running recording track JT is formed is set to twice of the maximum deviation track number MZ+α, the detection of the data recording start position is facilitated by seek using the address at the reference surface 3 with respect to the center track of the running recording track JT.

Although the running recording track JT is formed with the fixed track pitch, it may be formed, for example, by variable track pitch control (e.g., gradually enlarged), as a track deviated to the outer circumference as the recording track RT1e corresponding to additional recording.

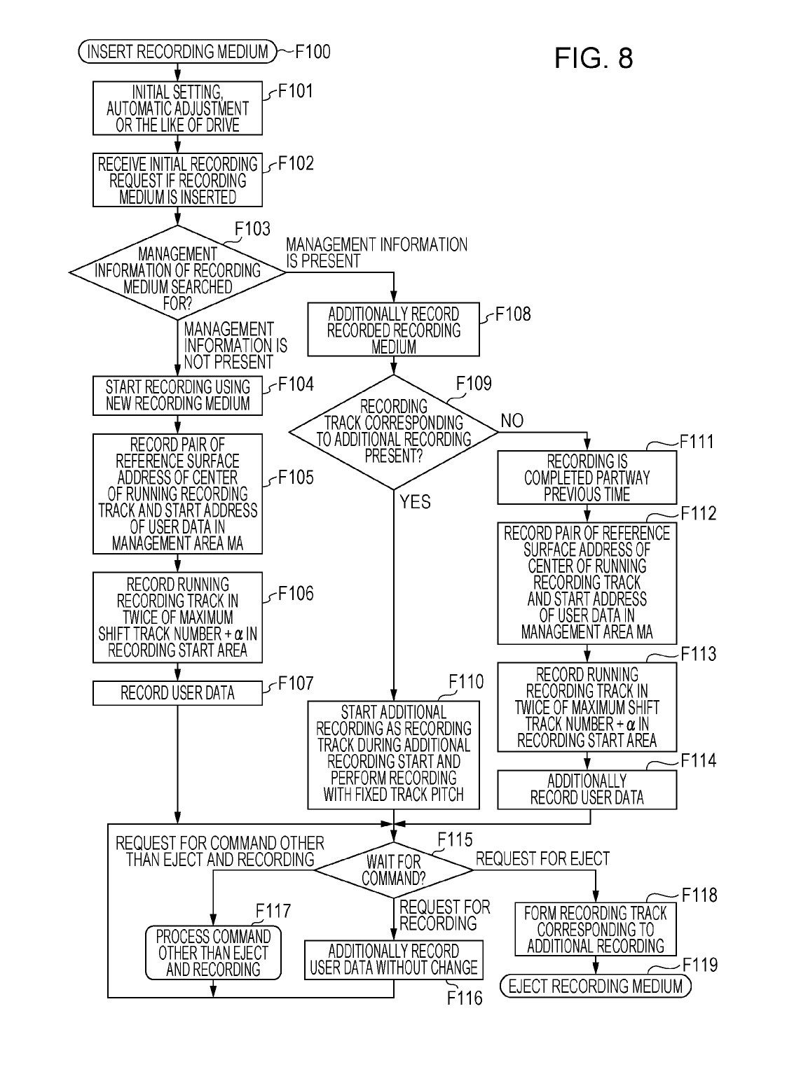

FIG. 8 illustrates a flowchart of an example sequential recording process of the recording/reproducing device 10 for executing a recording operation including the above points (PT1) to (PT3). FIG. 8 illustrates a control process during recording of the controller 62.

In step F100, when the recording medium 1 is loaded into the recording/reproducing device 10, the controller 62 first performs initial setting or various automatic adjustments in step F101.

Thereafter, in step F102, an initial recording request is received. For example, a recording request from a host apparatus connected with the recording/reproducing device 10 or a recording request by a user operation occurs.

In this case, the controller 62 progresses to step F103 and searches for the management information of the management area MA of the recording medium 1. The searching of the management information in this case indicates searching whether or not data recording was performed in the past and thus the management information according thereto is recorded. That is, it is determined whether the recording medium is a recording medium 1 in which user data was recorded once or more in the past or a recording medium 1 in which user data was not recorded.

If the recording medium is the recording medium 1 in which user data was not recorded in the past, the controller 62 progresses to step F104, determines that this recording request is for the execution of the recording onto a new recording medium 1 and performs a recording start process.

First, in step F105, a pair of an address at the reference surface 3 of the center of the running recording track JT to be recorded and a start logical address of user data is recorded in the management area MA.

In step F106, the controller 62 performs control for recording the running recording track JT from a recording start position, for example, an innermost circumferential position of the SRR in the radius range of twice of the maximum deviation track number+a.

In this case, dummy data is generated by the recording unit 55. While tracking control using the servo laser beam LZ2 is performed, the recording of the dummy data is executed by the optical pickup OP.

When the running recording track JT is recorded as a predetermined running track number section, the controller 62 executes the recording of the user data in step F107. That is, subsequently, the process of the user data is executed by the recording processing unit 55 and a laser driving signal based on the user data is supplied to the optical pickup OP. Thus, the actual recording of the user data is performed continuously to the running recording track JT.

In steps F105 to F107, the operation of the above point (PT3) is applied during the first recording of the user data on the recording medium 1.

Meanwhile, in step F103, if it is determined that the recording medium is the recording medium 1 in which the recording of the user data was performed once or more, the controller 62 progresses to step F108 and determines that this recording request is additional process of the recorded recording medium 1.

In this case, first, in step F109, it is checked whether or not the recording track RT1e corresponding to additional recording is present in the last of the recorded part.

That is, the rearmost part of the sequentially recorded user data is checked and the presence of the recording track RT1e corresponding to additional recording is checked, for example, depending on whether or not dummy data is recorded. In addition, when performing following by tracking servo of the recording/reproducing laser beam LZ1 at the rearmost part, information on the pits at the reference surface 3 may be monitored and checking as to whether or not the track pitch is gradually enlarged may be made so as to determine whether or not the recording track RT1e corresponding to additional recording is present.

If the recording track RT1e corresponding to additional recording is present, the controller 62 progresses to step F110. In this case, additional recording of user data is started as the recording track RT2s during the start of additional recording and, thereafter, the additional recording of the user is performed such that the recording track is formed with the fixed track pitch. That is, the operation of the above point (PT2) is executed.

More specifically, the track pitch is controlled to be gradually enlarged from the start of additional recording position, for example, in the ¼ circumferential section, by the below-described variable track pitch control. As described above, the track pitch is enlarged to twice or more of the maximum deviation track number. If the ¼ circumferential section is passed, the control is switched to the fixed track pitch control.

With respect to the recording processing unit 55, the laser driving signal based on the actually recorded user data is supplied to the optical pickup OP from the recording start time point by the recording track RT2s during the start of additional recording.

In step F109, if it is determined that the recording track RT1e corresponding to additional recording is not present, the controller 62 progresses to step F111 and determines that recording is restarted with respect to the recording medium 1 in which the recording is stopped partway the previous time.

In step F112, a pair of an address at the reference surface 3 of the center of the running recording track JT to be recorded and a start logical address of user data is recorded in the management area MA.

In step F113, the controller 62 performs control for recording the running recording track JT from a recording start position, for example, a position near the recording stoppage position (e.g., the position P10 of FIG. 7) in the radius range of twice of the maximum deviation track number+α.

In this case, dummy data is generated by the recording processing unit 55. While tracking control using the servo laser beam LZ2 is performed, the recording of the dummy data is executed by the optical pickup OP.

When the running recording track JT is recorded as a predetermined running track number section, the controller 62 executes the recording of the user data in step F114. That is, the process of the user data is executed by the recording processing unit 55 and a laser driving signal based on the user data is supplied to the optical pickup OP. Thus, the recording of the user data is performed continuously to the running recording track JT as the recording track RT2 of FIG. 7.

In steps F112 to F114, the operation of the above point (PT3) is applied during the recording stopped by the defect DF or the like is restarted.

The controller 62 waits for a command in step F115 after the recording of the user data of any one of step F107, F110 or F114 is finished.

If a certain command other than an eject command or a recording command is generated, in step F117, a process corresponding to the command is performed.

If the recording command is generated, the controller 62 progresses from step F115 to F116 and controls the execution of the recording of the user data according to the recording request. In this case, continuously to the rearmost part of the recording of the user data in step F107, F110 or F114, recording of new user data is performed with the fixed track pitch.

If the eject request for ejecting the recording medium 1 is generated, the controller 62 progresses from step F115 to F118. At this time, the formation of the recording track RT1e corresponding to additional recording is controlled. That is, the operation of the above point (PT1) is executed.

More specifically, the recording is executed while the track pitch is controlled to be gradually enlarged from the end position of the sequential recording of this time point, for example, in the ¼ circumferential section, by the below-described variable track pitch control. With respect to the recording processing unit 55, the laser driving signal based on dummy data is supplied to the optical pickup OP.

As described above, the track pitch is enlarged to twice or more of the maximum deviation track number, for example, in the ¼ circumferential section.

If the recording of the recording track RT1e corresponding to additional recording of the ¼ circumferential section is finished, the controller progresses to step F119, controls a loading mechanism of the recording medium 1, and ejects the recording medium 1 from the recording/reproducing device 10.

The controller 62 performs the control illustrated in FIG. 8 so as to execute the recording operation including the operations of the points (PT1) to (PT3) described in FIGS. 6 and 7.

Accordingly, it is possible to eliminate track overlapping or the like due to the spot deviation between the recording/reproducing laser beam LZ1 and the servo laser beam LZ2 and to increase reliability of the recording/reproducing operation. In addition, it is possible to narrow the track pitch and realize large capacity.

Although the formation of the above-described recording track RT1e corresponding to additional recording is performed just before eject as the point (PT1), it may be performed in the other cases.

For example, it is assumed that a power off request of the recording/reproducing device 10 is generated in a state in which the recording medium 1 is loaded. In this case, during the power off period, a user may take out the recording medium 1 using a certain method. Therefore, when the power off request of the recording/reproducing device 10 is generated in a state in which the recording medium 1 is loaded, similar to step F118, the recording track RT1e corresponding to additional recording may be formed and then the power off process may be performed.

That is, as timing when the recording track RT1e corresponding to additional recording, timing when the recording medium 1 may be ejected from the recording/reproducing device 10 is suitable.

Although the recording process of the above points (PT1) to (PT3) is described as the recording of the user data in the SRR, it is applied even when the management information is recorded in the management area MA.

For example, even when the recording of the management information is stopped partway due to influence such as defect, similarly, the recording continues through the running recording track JT.

Because a point in which this state is registered is not present, if dummy data (recording last mark) is not detected from the rearmost part of the management area, it is necessary to search whether the management information is not recorded thereafter using the servo based on the pits at the reference surface 3 or the like.

The recording/reproducing device 10 may include a plurality of optical pickups OP.

In FIG. 4B, it is possible to efficiently control the plurality of optical pickups OP by including a plurality of sequential recording areas (SRRs).

For example, recording is executed using a first optical pickup OP with respect to SRR1 and recording is executed using a second optical pickup OP with respect to SRR2.

As so-called striping, user data is divided and recording/reproduction of SRR1 and SRR2 is simultaneously performed. SRR information or striping method information is recorded in the management area MA (MA1 and MA2).

Accordingly, it is possible to improve recording/reproducing performance.

Although the recording/reproducing device 10 is described as a device for performing all the recording processes of the points (PT1) to (PT3) in the process of FIG. 8, some process may be performed.

For example, in the case where the recording/reproducing device 10 of the present embodiment forms the recording track RT1e corresponding to additional recording of the point (PT1), it is possible to decrease a possibility that track overlapping occurs when additional recording is performed by a recording device other than the present disclosure.

In the case where the recording/reproducing device 10 of the embodiment forms the recording track RT2s during the start of additional recording of the point (PT2), it is possible to decrease a possibility that track overlapping occurs when additional recording is performed with respect to the recording medium 1 recorded by a recording device other than the present disclosure.

In the case where the recording/reproducing device 10 of the embodiment performs user data recording after forming the running recording track JT of the point (PT3), it is possible to reduce the influence of the spot deviation between both laser beams LZ1 and LZ2 other than before and after eject.

Accordingly, the recording device which performs at least one operation of the points (PT1) to (PT3) is useful as the recording device using the recording/reproducing laser beam LZ1 and the servo laser beam LZ2.

[4. Tracking Method]

The above-described recording track corresponding additional recording and recording track during the start of additional recording may not formed by the tracking control to only follow the ideal track defined in the reference surface 3. That is, as described in FIG. 6, it is necessary to perform tracking control such that the track straddles the ideal track to be gradually deviated in the track pitch direction.

Now, an example of a tracking method for realizing a variable track pitch necessary for forming the recording track corresponding to additional recording and the recording track during the start of additional recording will be described.

FIG. 9 illustrates pit rows formed in the reference surface 3 in the recording medium 1.

In order to enable the variable track pitch control, in the recording medium 1 used in the present example embodiment, pit rows illustrated FIG. 9 are formed in the reference surface 3.

In FIG. 9, a direction from the left to the right of paper is a pit row forming direction, that is, a track forming direction. The spots of the servo laser beam LZ2 move from the left to the right of paper according to the rotation and driving of the recording medium 1.

In addition, a direction (e.g., a vertical direction of paper) perpendicular to the pit row forming direction is the radius direction of the recording medium 1.

In FIG. 9, A to F denoted by white circles of the drawing denote pit formable positions. That is, in the reference surface 3, the pit is formed only at the pit formable position and the pit is not formed at positions other than the pit formable position.

The reference numbers A to F of the drawing are illustrated for distinguishing the pit rows (pit rows arranged in the radius direction) and numerals postfixed to the reference numerals A to F are illustrated for distinguishing the pit formable positions on the pit rows.

A gap denoted by black thick lines of the drawing corresponds to the general track pitch of the recording track in the recording medium 1. For example, it is defined as a minimum track pitch realized as a recording/reproducing track or the like.

That is, in the reference surface 3 of the recording medium 1, a total of six pit rows A to F are arranged in the width of one general track in the radius direction.

If the plurality of pit rows is simply arranged in one track width, the pit formation positions may overlap each other in the pit row forming direction and, as a result, the gap between the pits in the pit row forming direction may exceed an optical limit.

In the present embodiment, by employing the below-described variable track pitch control method, it is necessary to individually obtain tracking error signals of the pit rows of A to F at the recording/reproducing device side.

That is, even in this point, it is necessary to perform research into the arrangement of the pit rows.

With respect to the pit rows formed in the reference surface 3, the following conditions are set.

That is, 1) In the pit rows of A to F, the gap between the pit formable positions is limited to a predetermined first gap.

2) The pit rows of A to F, the gap between the pit formable positions of which is limited are arranged such that the pit formable positions are deviated by a predetermined second gap in the pit row forming direction (that is, the phases of the pit rows are deviated by the second gap).

The gap (second gap) in the pit row forming direction of the pit formable position of the pit rows of A to F arranged in the radius direction is set to n. At this time, the pit rows of A to F are arranged so as to satisfy the condition 2) such that all the gaps between the pit formable positions of the pit row A-B, the pit row B-C, the pit row C-D, the pit row D-E, the pit row E-F and the pit row F-A becomes n as illustrated.

The gap (first gap) between the pit formable positions of the pit rows of A to F becomes 6n because the phases of the total of six pit rows of A to F are realized.

That is, with respect to the plurality of pit rows of A to F having different pit row phases, the basic period thereof is set to 6n and then the phases thereof are deviated by n.

Thus, in the below-described variable track pitch control, it is possible to individually obtain the tracking error signals of the pit rows of A to F.

At the same time, as in the present example, in the case where the pit rows of A to F are arranged in one track width of the limit of the related art, it is possible to prevent the gap between the pits in the pit row forming direction from exceeding the optical limit.

The arrangement of the pit rows of A to F in one track width of the limit of the related art and the narrowing of the forming pitch in the radius direction of the pit rows cause the spot position control by the below-described variable track pitch control to be performed with higher precision.

In the present embodiment, the servo laser beam LZ2 used in the information reproduction in the reference surface 3 has conditions of a wavelength of λ=650 and a numerical aperture NA=0.65 similar to a DVD. In correspondence therewith, the section length of each pit formable position is set to a section length of 3 T equal to that of a shortest mark of the DVD, and the gap between the edges of the pit formable positions of A to F in the pit row forming direction is similarly set to a length of 3 T.

As a result, the conditions 1) and 2) are satisfied.

Subsequently, in order to understand the forming of the pits in the reference surface 3, the method of forming the pit rows will be described in more detail with reference to FIG. 10.

In FIG. 10 schematically illustrates a part (7 pit rows) of the pit rows formed in the reference surface 3 of the recording medium 1. In the drawing, a black circle denotes the pit formable position.

As can be seen from FIG. 10, in the recording medium 1, the pit rows are formed in a spiral shape.

By setting the pit formable positions such that the pit row phases are deviated by the second gap “n” in circumference of the pit rows, the conditions 1) and 2) are satisfied with respect to the pit rows arranged in the radius direction.

For example, FIG. 10 illustrates that the pit formable positions are set such that the pit row phases as the pit rows A are obtained in a first circumference of the pit rows, and the pit formable positions are set such that the pit row phases as the pit rows B are obtained in a second circumference of the pit rows based on circumference start position (predetermined angle position) of the drawing. Thereafter, similarly, the pit formable positions are set such that the pit row phases as the pit rows C are obtained in a third circumference and, the pit formable positions of each circumference of the pit rows are set such that the pit row phases are deviated by the second gap n in circumference of the pit rows, such as pit rows D in a fourth circumference, pit rows E in a fifth circumference, pit rows F in a sixth circumference, and pit rows A in a seventh circumference.

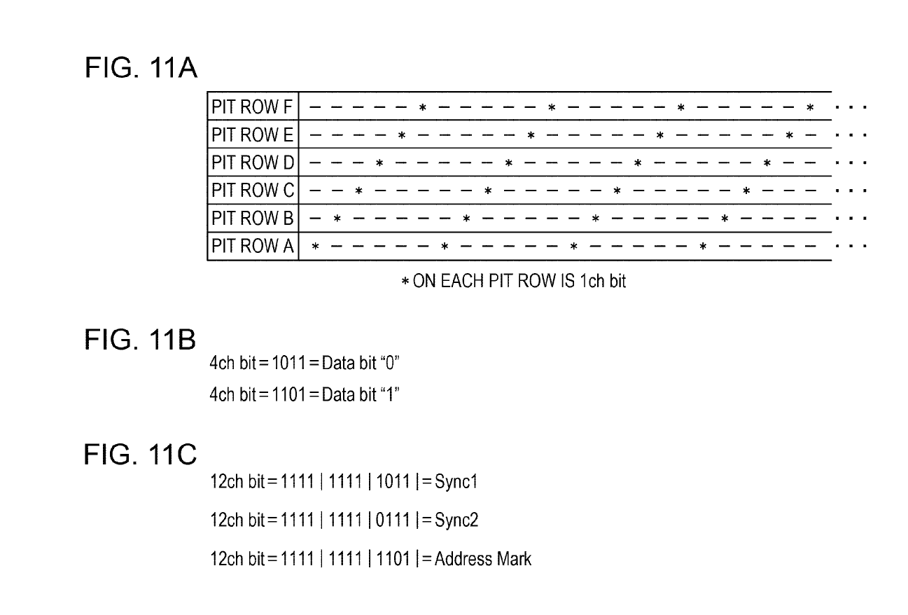

Subsequently, an example of a format of address information recorded in the reference surface 3 will be described with reference to FIGS. 11A to 11C.

FIG. 11A schematically illustrates a relationship between the pit formable positions of the pit rows A to F having different pit row phases. In FIG. 11A, the pit formable positions are denoted by a mark “*”.

As described below, the recording/reproducing device 10 of the present embodiment selects one of the pit rows A to F and performs tracking servo with respect to the selected one pit row.

At this time, in the reference surface 3 of the recording medium 1, all the pits of A to F are applied as the tracking error signal obtained by moving (scanning) the optical spot on the track. That is, in this case, even when the tracking servo is performed based on the tracking error signal itself obtained by scanning the reference surface 3 by the optical spot, it is extremely difficult to follow the selected one pit row.

To this end, the recording/reproducing device 10 of the present embodiment uses a method of extracting the tracking error signal of the pit formable position of the selected pit row and intermittently performing tracking servo based on the extracted tracking error signal, as described below.

Similarly, even when address information is read, a method of extracting a sum signal (the below-described sum signal) of the section of the pit formable position of the selected pit row and detecting address information based on the extracted sum signal such that only information recorded in the selected pit row is selectively read is used.

In order to cope with the information detecting method, in the present embodiment, a format which represents “0” and “1” of channel data by the formation/non-formation of the pit at the pit formable position is employed. That is, one pit formable position assumes information on one channel bit.

Then, one bit of a data bit is represented by a data pattern “0” or “1” using a plurality of channel bits.

More specifically, as illustrated in FIG. 11B, “0” or “1” of the data bit is represented by four channel bits. For example, the pattern “1011” of four channel bits represents the data bit “0” and the pattern “1101” of four channel bits represents the data bit “1”.

At this time, it is important that the channel bit “0” is not consecutive.

The consecutive channel bit “0” means that periods without an error signal are consecutive when servo is intermittently performed using the tracking error signal as described above. Then, it is difficult to secure precision of tracking servo.

To this end, for example, by the above definition of the data bit, a condition that the channel bit “0” is not consecutive is satisfied. That is, it is possible to minimize the deterioration of the precision of the tracking servo by the above definition of the data bit.

FIG. 11C illustrates an example of a sync pattern.

For example, as illustrated, the sync pattern is represented by 12 channel bits. 8 bits of the front half are set to a channel bit pattern “11111111” so as not to conform the definition of the data bit and the other (kind) of the sync is represented by the pattern of the remaining four channel bits.

Specifically, Sync1 is set if the pattern of four channel bits subsequent to the above 8 bits is “1011”, and Sync2 is set if the pattern of four channel bits is “0111”. If “1101”, an address mark is set.

In the recording medium 1, address information is recorded after the above sync.

Here, as address information, at least information on a radius position and information on an angle position are recorded.

Although, in the present example, a plurality of pit rows of A to F is arranged in one track width of the limit of the related art, the recording of the address information is performed so as to allocate individual information to each pit row such that the radius position of each pit row is individually represented.

That is, the same address information is not recorded with respect to the pit rows of A to F arranged in one track width of the limit of the related art.

Subsequently, a method of realizing variable track pitch control will be described.

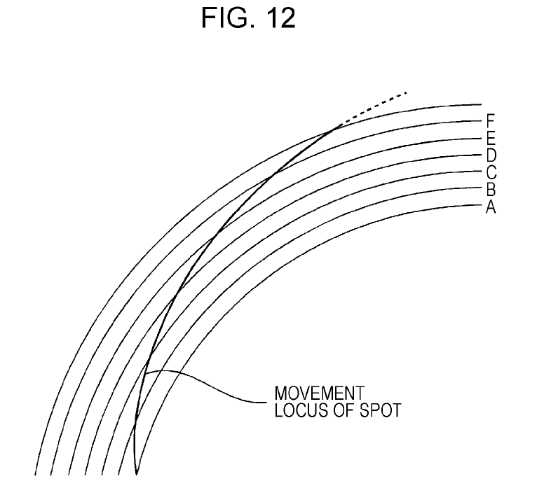

First, the summary of the method realizing the variable track pitch will be described with reference to FIG. 12.

In addition, FIG. 12 illustrates a set of pit rows of A to F having different pit row phases, which is formed in the recording medium 1, and a movement locus of the beam spots.

As illustrated in FIG. 12, in the formation of the recording track with a variable track pitch which does not depend on the pitch of the previously formed pit rows, the beam spots moving according to the rotation of the recording medium 1 straddle (pass over) the sequential pit rows. That is, the passing-over gap of the pit rows is set in advance according to a variable pitch to be realized so as to realize a recording track (that is, the recording track corresponding to additional recording or the recording track during the start of additional recording), the track pitch of which is gradually changed.

The movement of the beam spot is realized by applying an offset to a tracking servo loop.

Specifically, in a state in which the tracking servo is turned on, an offset, the value of which is increased with time, is applied to the tracking servo loop such that the beam spot is gradually separated from the pit rows to be subjected to servo.

At a time when the light spot is separated from the pit row to be subjected to servo to some extent, the pit row to be subjected to servo is switched to a pit row adjacent to the outer circumference and an offset, the value of which is increased with time, is similarly applied to the tracking servo loop. Thus, the beam spot is gradually separated from the pit row, which is newly switched to be subjected to servo, to the outer circumferential side.

By repeatedly performing the application of the offset to the tracking servo loop and the sequential switching of the pit row to be subjected to servo, the beam spot straddles each pit row in a tightrope walking manner. Then, it is possible to realize the variable track pitch which does not depend on the pitch of the formed pit rows. At this time, by the setting of the slope of the offset applied to the tracking servo loop, it is possible to arbitrarily set the change state of the track pitch.

As can be understood from the above description, in the method of the present embodiment, it is necessary to sequentially switch the pit row to be subjected to servo to a pit row adjacent to the outer circumferential side, such as the pit row A, the pit row B, the pit row C, . . . .

At this time, in order to realize the operation for sequentially switching the pit row to be subjected to servo, it is necessary to individually obtain the tracking error signal of the pit rows by the phases of A to F. That is, if the tracking error signals of the pit rows of A to F are not distinguished, it is difficult to originally switch the pit row to be subjected to servo.

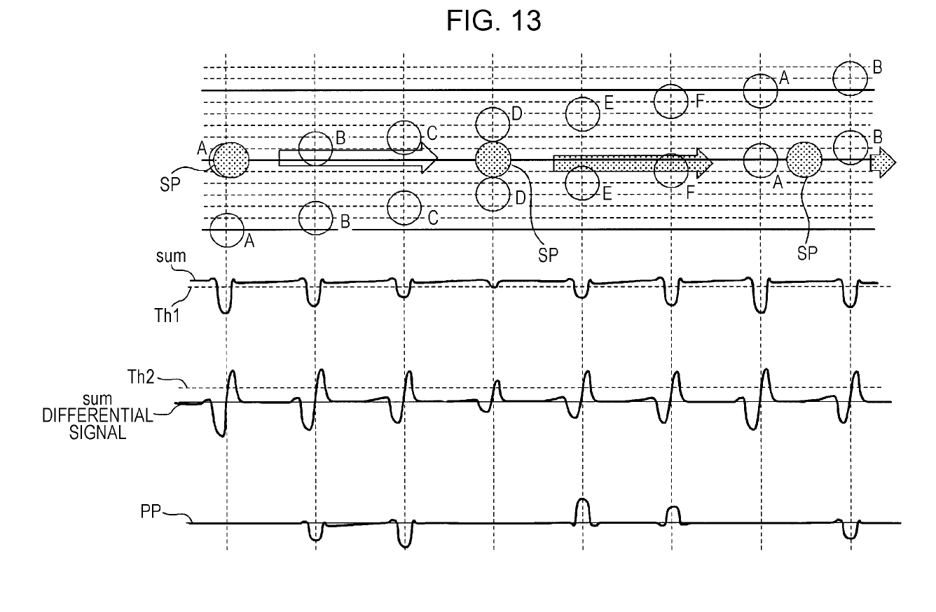

Hereinafter, first, a method of individually obtaining the tracking error signals of the pit rows of A to F will be described with reference to FIGS. 13 to 15.

FIG. 13 schematically illustrates a state in which the spot of the servo laser beam LZ2 moves on the reference surface 3 according to the rotation and driving of the recording medium 1 and a relationship among the waveforms of a sum signal, a sum differential signal and a Push-Pull (PP) signal obtained at this time.

The sum signal is a sum signal of light-sensing signals obtained by a plurality of light-sensing elements as the light-sensing portion 54 for the servo light illustrated in FIG. 5, and the sum differential signal is obtained by differentiating the sum signal.

The PP signal is a signal computed so as to represent the positional deviation amount in the tracking direction of the spot position relative to the pit from the light-sensing signal of the light-sensing portion 54 for the servo light, that is, a signal as a tracking error component.

In FIG. 13, for convenience of description, the pits are formed at all the pit formable positions of the drawing.

As denoted by an arrow of the drawing, as the beam spot SP of the servo laser beam LZ2 moves according to the rotation of the recording medium 1, the signal level of the sum signal becomes a peak in a period according to the arrangement gap in the pit row forming direction of the pits of A to F. That is, this sum signal represents a gap (forming period) in the pit row forming direction of the pits of A to F.

In the example of this drawing, because the beam spot moves along the pit row A, the peak value becomes a maximum when the sum signal passes through the forming position of the pit A in the pit row forming direction. In addition, the peak value is gradually decreased over the forming positions of the pit B to the pit D. Thereafter, the peak value is increased in order of the forming position of the pit E and the forming position of the pit F, and the peak value becomes a maximum when reaching the forming position of the pit A again.

That is, in the forming positions of the pit E and F in the pit row forming direction, because the influence of the pits of the pit rows E and F adjacent to the inner circumferential side is received, the peak value of the sum signal is sequentially increased at the forming positions of the pits E and F.

As the sum differential signal generated by differentiating the sum signal and the PP signal, it is possible to obtain the illustrated waveforms.

The PP signal is obtained by representing the relative positional relationship between the beam spot and the pit row at each of the pit formable positions of A to F separated by the predetermined gap n as described in FIG. 9. This is because, in the recording medium 1, for example, the pit rows of A to F are arranged in one track width of the related art, that is, the pit rows are closely arranged in the radius direction.

The sum differential signal is used to generate a clock CLK according to the gap in the pit row forming direction of the pit forming positions (strictly, the pit formable positions) of the pit rows A to F as described below.

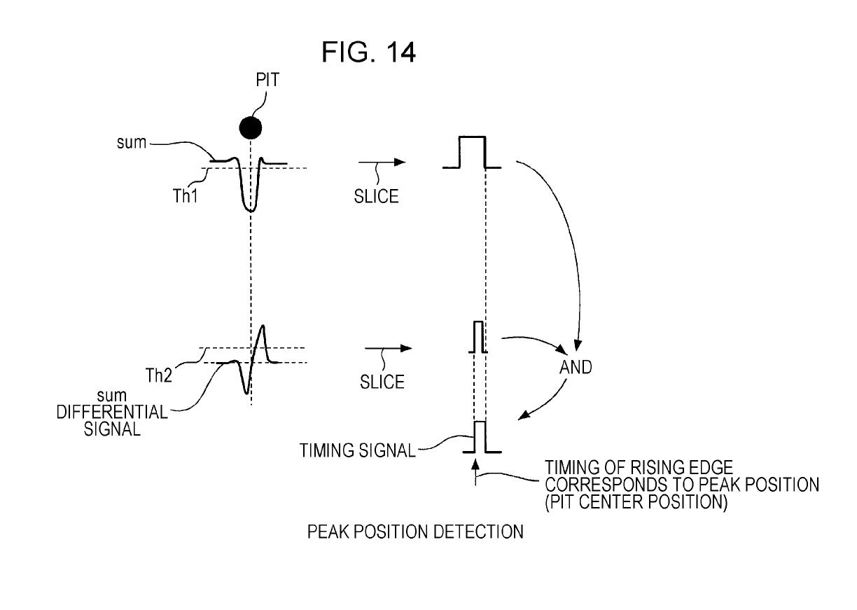

FIG. 14 illustrates a timing signal generated based on the sum differential signal and the sum signal, in the generation of the clock CLK.

In this example, a signal having a position (timing) corresponding to a center position (peak position) of each pit as a rising position (timing) is generated as the clock CLK.

Specifically, a signal obtained by slicing the sum signal by a predetermined threshold value Th1 illustrated in FIGS. 13 and 14 and similarly a signal obtained by slicing the sum differential signal by a predetermined threshold value Th2 are generated and are subjected to AND. Thus, a timing signal having a rising timing corresponding to the peak position is generated.

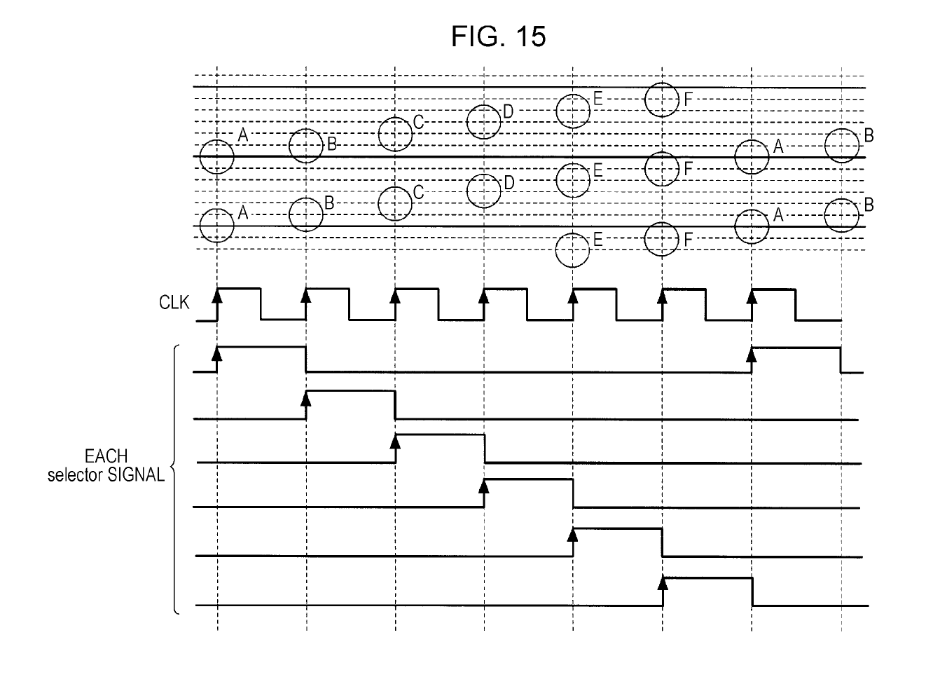

FIG. 15 schematically illustrates the relationship among the clock CLK generated from the timing signal generated by the above procedure, the waveforms of selector signals generated based on the clock CLK, and the pit rows formed in the reference surface 3 of the recording medium 1.

As illustrated, the clock CLK becomes a signal which rises at timing corresponding to the peak position of each pit (pit formable position) and falls at an intermediate point between the rising positions.

Such a clock CLK is performed by performing a Phase Locked Loop (PLL) process using the generated timing signal as an input signal (reference signal).

From the clock CLK having a period according to the formation gap of the pits A to F, six selector signals representing the timings of the pit formable positions of A to F are generated. Specifically, the selector signals are generated by dividing the clock CLK by ⅙ and the phases thereof are divided by ⅙ period. In other words, the selector signals are generated such that the rising timings thereof are deviated by ⅙ period, by dividing the clock CLK by ⅙ at each timing.

The selector signals become signals representing the timings of the pit formable positions of the corresponding pit rows of A to F. In the present embodiment, the selector signals are generated, a certain selector signal is selected, and the tracking servo control is performed according to the PP signal in the period represented by the selected selector signal. Accordingly, the beam spot of the position control light is traced on a certain pit row among the pit rows of A to F.

Accordingly, it is possible to arbitrarily select the pit row to be subjected to servo from the pit rows of A to F.

The selector signals representing the timings of the pit formable position of the corresponding pit rows of A to F are generated, a certain selector signal is selected therefrom, and the tracking servo control is performed based on the tracking error signal (PP signal) in the period represented in the selected selector signal. Accordingly, it is possible to realize tracking servo with respect to the certain pit row among A to F.

That is, it is possible to change the tracking error signal of the pit row to be subjected to servo by the selection of the selector signal and to realize the change of the pit row to be subjected to servo.

FIG. 16 illustrates the relationship between the offset applied to the tracking error signal TE as the variable track pitch control and the movement locus of the beam spot in the reference surface 3 of the recording medium 1.

The tracking error signal TE is a signal obtained by sampling and holding the PP signal based on the selector signal, that is, the PP signal (e.g., signal of the tracking error component) of the pit row to be subjected to servo.

In FIG. 16, a state in which the beam spot passes over the pit row A to the pit row B by the application of the offset is illustrated.

First, if the method of sequentially switching the pit row to be subjected to servo is employed in the realizing of a certain track pitch, the change position (timing) is set in advance. In the present embodiment, the change position of the pit row to be subjected to servo is set to a position (in the radius direction) which is an intermediate point between the adjacent pit rows.

When a certain track pitch is realized, a position through which the beam spot passes on the reference surface 3 may be obtained by computation such as the format of the reference surface 3 in advance, in order to realize the track pitch. That is, the position where the beam spot reaches the intermediate point between adjacent pit rows may be obtained by computation in advance.

Depending on the position (which clock of which address block) as the intermediate point obtained by computation or the like in advance, the pit row to be subjected to servo is switched to a pit row adjacent to the outside of the pit row which has been subjected to servo up to that time.

The movement between the pit rows of the beam spot is realized by applying the offset having a saw-like wave shape to the tracking error signal TE as illustrated.

That is, by the setting of the slope of this offset, it is possible to set (change) the track pitch to a certain pitch.

In order to realize a spiral-shaped trace, the beam spot is moved to the outer circumferential side by the rising of the value of the offset.

In the present example, the offset is applied to the tracking error signal TE. Accordingly, the polarity of the offset by the waveform illustrated in FIG. 16 is inverted and then is added to the tracking error signal TE. That is, the offset is applied by calculation of “error signal TE−offset”.

The offset which is applied in order to realize a certain track pitch has a waveform in which the polarity is changed in every intermediate point, from the relationship for performing the change of the pit row to be subjected to sequential servo with respect to the timing when the beam spot reaches the intermediate point between the adjacent pit rows as described above.

That is, because the offset amount necessary for moving the beam spot at the position which becomes the intermediate point, for example, is “+α” during the servo which is performed with respect to the pit row A and is “−α” during the servo which is performed with respect to the adjacent pit row B, in the switching timing of the pit row to be subjected to servo as the timing reaching the intermediate point, it is necessary to invert the polarity of the offset. From this point, the waveform of the offset applied in this case becomes the waveform of the saw-like wave as described above.

The waveform of the offset is obtained based on the information on the track pitch to be realized and the information on the format of the reference surface 3 by computation or the like in advance.

While the offset of the predetermined saw-like wave is applied to the tracking error signal TE, at the timing when the beam spot reaches a predetermined position between the adjacent pit rows, which is previously determined as the intermediate point, the pit row to be subjected to tracking servo is switched to a pit row adjacent to the outside of the pit row which has been subjected to servo up to now.

Thus, it is possible to control the position of the beam spot so as to realize a certain track pitch. In other words, as the above-described recording track corresponding to additional recording and the recording track during the start of additional recording, as illustrated in FIG. 6, it is possible to perform tracking control so as to straddle the ideal track so as to be gradually deviated in the track pitch direction.

FIG. 17 illustrates the configuration of the recording/reproducing device 10 for realizing the above variable track pitch control and, more particularly, illustrates a tracking error generation unit 63 in the configuration of FIG. 5 in detail. In addition, in FIG. 17, only a portion related to the servo control system using the servo laser beam LZ2 in the FIG. 5 is illustrated.

In FIG. 17, the light-sensing signal obtained by the light-sensing portion 54 for the servo light in the optical pickup OP described in FIG. 5 is input to the matrix circuit 59 for the servo light.

The matrix circuit 59 for the servo light generates the sum signal as the above-described sum signal, the PP signal as the signal of the tracking error component, and a focus error signal FE-sv, based on the light-sensing signal.

The PP signal generated by the matrix circuit 59 for the servo light is supplied to a sample and hold circuit 15.

The sum signal is supplied to a clock generation circuit 11 and a position information detection unit 60. In this case, a signal AD for address reproduction described in FIG. 5 becomes the sum signal.

The focus error signal FE-sv is supplied to the servo circuit 61 for the servo light.

The clock generation circuit 11 generates the clock CLK according to the above-described procedure.

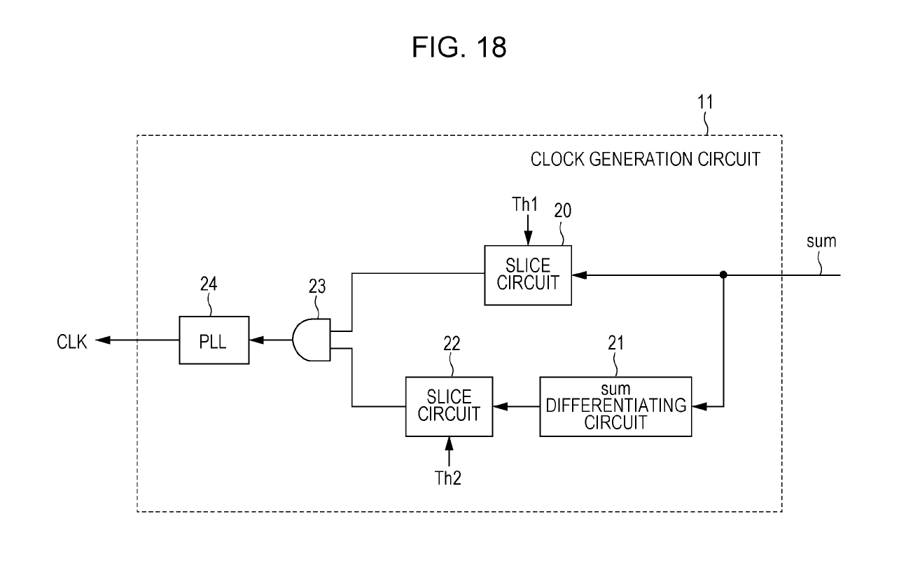

FIG. 18 illustrates the internal configuration of the clock generation circuit 11. As illustrated in FIG. 18, a slice circuit 20, a sum differentiating circuit 21, a slice circuit 22, an AND gate circuit 23 and a PLL circuit 24 are provided in the clock generation circuit 11.

The sum signal from the matrix circuit 59 for the servo light is supplied to the slice circuit 20 and the sum differentiating circuit 21 as illustrated.

The slice circuit 20 slices the sum signal based on the set threshold value Th1 and outputs the result to the AND gate circuit 23.

The sum differentiating circuit 21 differentiates the sum signal and generates the above-described sum differential signal. The slice circuit 22 slices the sum differential signal generated by the sum differentiating circuit 21 based on the set threshold value Th2 and outputs the result to the AND gate circuit 23.

The AND gate circuit 23 performs AND of the output of the slice circuit 20 and the output of the slice circuit 22 and generates the above-described timing signal.

The PLL circuit 24 performs a PLL process using the timing signal obtained by the AND gate signal 23 as an input signal and generates the above-described clock CLK.

In FIG. 17, the clock CLK generated by the clock generation circuit 11 is supplied to the selector signal generation circuit 12. Although omitted for convenience, the clock CLK is used as the operation clock of each necessary unit (e.g., the controller 62, the saw-like wave generation circuit 17, or the like).

The selector signal generation circuit 12 generates the six selector signals representing the timings of the pit formable positions of the pit rows of A to F based on the clock CLK. Specifically, the selector signal generation circuit 12 generates the signals, the phases of which are deviated by ⅙ period, as the signals obtained by dividing the clock CLK by ⅙ and obtains the six selector signals illustrated in FIG. 15.

The selector signal selection/phase adjustment circuit 13 selects and outputs one selector signal from among the six selector signals generated by the selector signal generation circuit 12, based on a selection signal SLCT by the controller 62.

In addition, one selector signal selected by the selection signal SLCT is set to selector-x as illustrated.

The selector signal selection/phase adjustment circuit 13 performs a process of adjusting the phase of the selector signal based on an adjustment signal ADJ supplied by the controller 62 and this will be described later.

The selector signal (selector-x) selected by the selector signal selection/phase adjustment circuit 13 is supplied to the sample and hold circuit 15 and the position information detection unit 60.

The sample and hold circuit 15 includes an A/D converter and samples and holds the PP signal supplied from the matrix circuit 59 for the servo light by a rising edge of the selector signal (selector-x) selected by the selector signal selection/phase adjustment circuit 13.

The PP signal sampled and held by the sample and hold circuit 15 is denoted by a tracking error signal TE in the drawing.

The tracking error signal TE is input to an adder 16.

The tracking error signal TE and the output signal of the saw-like wave generation circuit 17 are input to the adder 16.

The adder 16 adds the output signal of the saw-like wave generation circuit 17 to the tracking error signal TE and outputs the result to the servo circuit 61 for the servo light as the tracking error signal TE-sv.

As described above, in order to move the beam spot to the outer circumferential side by the rising of the offset value, the offset value, the polarity of which is inverted, is added to the tracking error signal TE. That is, the adder 16 functions as a subtractor for performing calculation of “tracking error signal TE−offset value”.

The saw-like wave generation circuit 17 generates the saw-like wave for realizing the variable track pitch obtained by computation in advance, as described in FIG. 16.

In the saw-like wave generation circuit 17, information on a value to be added to the tracking error signal TE in clock units is set as information for generating the saw-like wave for realizing the preobtained variable track pitch. The saw-like wave generation circuit 17 sequentially outputs the value set in clock units to the adder 16.

As illustrated in FIG. 16, it is possible to apply the offset by the saw-like wave to the tracking error signal TE.

The servo circuit 61 for the servo light performs servo calculation based on the tracking error signal TE-sv to which the offset is applied by the adder 16, and generates and supplies a tracking drive signal TD-sv to the biaxial actuator 46 in the optical pickup OP.

By driving and controlling the biaxial actuator 46 based on the tracking drive signal TD-sv, the spot position of the servo laser beam LZ2 is controlled so as to be separated from one pit row to be subjected to servo among the pit rows of A to F by the application of the offset.

The servo circuit 61 for the servo light may turn off the tracking servo loop according to a jump instruction (pit row jump instruction) from the controller 62, and outputs a jump pulse as the tracking drive signal TD-sv, thereby executing a jump operation between pit rows.

The servo circuit 61 for the servo light performs servo calculation based on the focus error signal FE-sv, and generates and applies the focus drive signal FD-sv to the biaxial actuator 46, thereby performing focus servo control.

The position information detection unit 60 performs the detection of the address information recorded by the pit rows based on the result of identifying H/L of the sum signal supplied from the matrix circuit 59 for the servo light according to the timing represented by the selector signal (selector-x) supplied from the above-described selector signal selection/phase adjustment circuit 13.

As described in FIG. 11, the address information of each pit row is recorded using the formation/non-formation of the pit at the pit formable position of that pit row as information of 1 channel bit. Thus, the position information detection unit 60 identifies H/L of the sum signal at the rising timing of the selector signal so as to perform data identification of “0” or “1” of one channel bit and performs an address decoding process according to the format described in FIG. 11 based on the result. Accordingly, the recorded address information is detected (reproduced).

The address information detected by the position information detection unit 60 is supplied to the controller 62.

The controller 62 performs control for generating the recording track with the fixed track pitch during the general recording operation and control for generating the above-described recording track corresponding to the start of additional recording and recording track during the start of additional recording, in regard to the tracking control.

First, the control of the general recording operation with the fixed track pitch will be described.

In this case, the controller 62 performs control for adjusting the phase of the selector signal in every circumference of the pit rows in an ON state of the tracking servo.

As can be understood from the description of FIG. 11, in the recording medium 1, the phases of the pit rows are different in every circumference of the pit rows. To this end, after a position (that is, a start position of a next circumference) where circumference of the pit rows ends, the phases of the selector signals are deviated.

During the general tracking control with the fixed track pitch, a process of adjusting the phase deviation of the selector signals in every circumference is performed.

Specifically, the controller 62 instructs the selector signal selection/phase adjustment circuit 13 to adjust the corresponding phase adjustment amount by the adjustment signal ADJ in every circumference based on information on the predetermined phase adjustment amount of every circumference.

The selector signal selection/phase adjustment circuit 13 adjusts the phases of the selector signals by the phase adjustment amount instructed by the adjustment signal ADJ. Thus, it is possible to correct the phase deviation generated by the selector signals in every circumference.

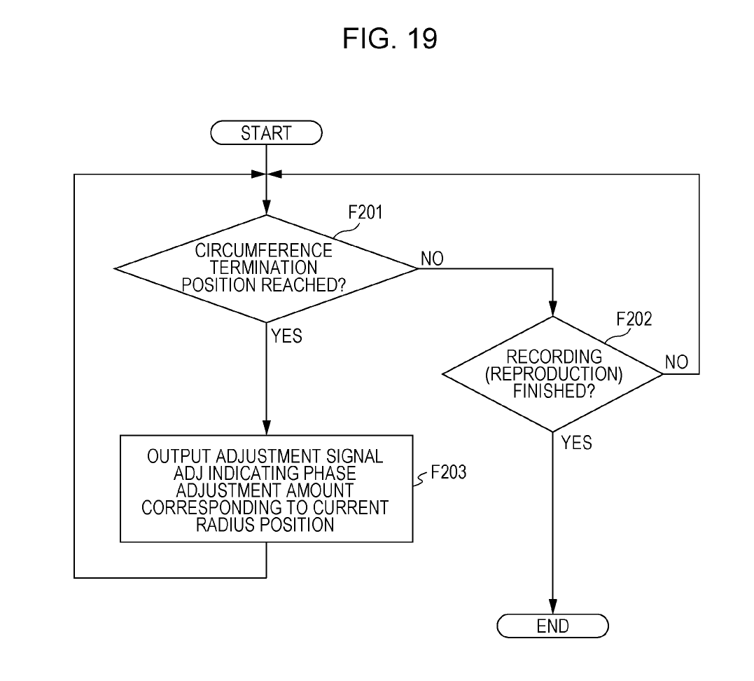

FIG. 19 illustrates a phase adjustment control process of circumference, which is performed by the controller 62.

First, the controller 62 waits until reaching a circumference termination position or recording (or reproduction) is terminated by processes of step F201 and F202.

As described above, because a predetermined angle position is set to the start position of circumference, the determination as to whether or not circumference termination position is reached in step F201 may be made based on the address information detected by the position information detection unit 60.

If it is determined that the circumference termination position is reached in step F201, the controller 62 progresses to step F203 and outputs the adjustment signal ADJ for instructing the phase adjustment amount according to the current radius position. Then, the controller returns to step S201.

That is, as the “information on the predetermined phase adjustment amount of each circumference”, in this case, table information in which information on the phase adjustment amounts corresponding to the pit rows (radius positions) are stored is used. In step F203, based on the table information, the information on the phase adjustment amount according to the current radius position is acquired and is instructed to the selector signal selection/phase adjustment circuit 13 by the adjustment signal ADJ.

The controller 62 finishes the process illustrated in FIG. 14 if it is determined that the recording (or the reproduction) is finished in step F202.

Although the phase adjustment amount of every circumference is determined in advance, for example, if regularity is present in the phase deviation amount of every circumference, or the like, the phase adjustment amount may be computed and obtained in every circumference.

Meanwhile, the tracking control when the recording track corresponding to additional recording and the recording track during the start of additional recording are generated will be performed as follows.

That is, the controller 62 performs the change control of the pit rows to be subjected to servo at each predetermined timing, in order to gradually enlarge the track pitch.

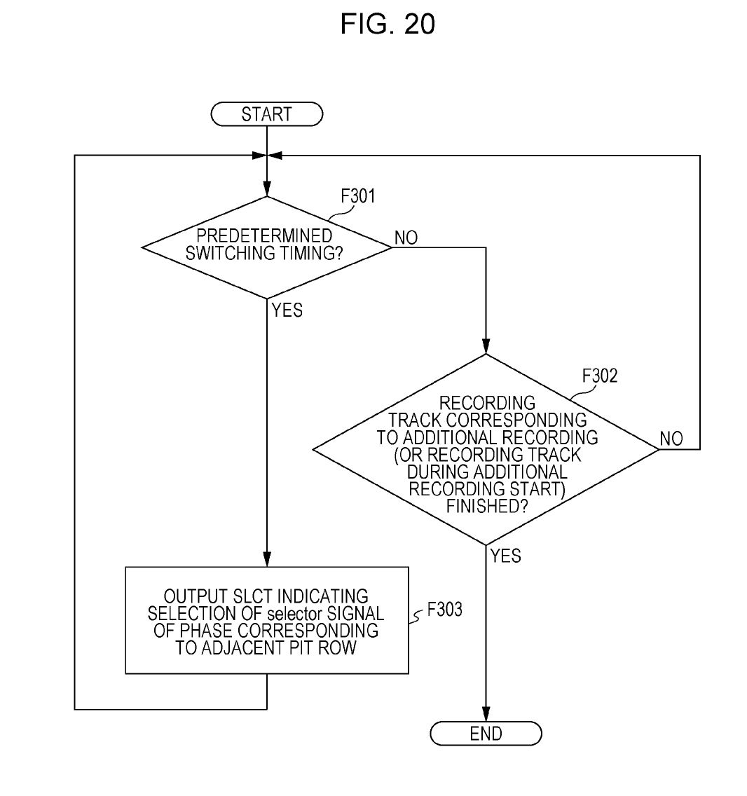

FIG. 20 illustrates the procedure of the change control process of the pit rows to be subjected to servo, which is performed by the controller 62.

The controller 62 monitors whether a predetermined switching timing is reached, or the recording track corresponding to additional recording or the recording track during the start of additional recording is finished, in steps F301 and F302.

For example, in FIG. 6, if the track pitch is gradually enlarged in the ¼ circumferential section, the predetermined switching timing is timing of every period obtained by subdividing the period of the ¼ circumference.

The determination as to whether or not the predetermined switching timing is reached may be made from the current beam spot position specified by the clock CLK and the address information detected by the position information detection unit 60.

If it is determined that the predetermined switching timing is reached in step F301, the controller 62 progresses to step F303 and outputs the selection signal SLCT for instructing the selection of the selector signal having the phase corresponding to the adjacent pit row.

That is, the selection signal SLCT for instructing the selection of the selector signal, the phase of which is delayed from the selector signal selected up to that time by the predetermined period n, such that the pit row to be subjected to servo is switched from the pit row selected up to that time to the pit row adjacent to the outside of the pit row.

By executing the process of step F303 at the every predetermined switching timing, the spot position of the recording/reproducing laser beam LZ1 is gradually deviated to the outer circumferential side.

The controller 62 finishes the control of FIG. 20, if it is determined that the recording of the recording track corresponding to additional recording or the recording track during the start of additional recording is finished, for example, the recording of the predetermined section such as the ¼ circumferential section is finished in step F302.

When the recording of the recording track corresponding to additional recording is performed, the recording operation is also finished at this time.

In addition, when the recording of the recording track during the start of additional recording is performed, the tracking control of FIG. 19 is subsequently performed and the recording of the user data with the fixed track pitch is performed.

By performing the above-described tracking control, it is possible to perform the recording operation of the present embodiment, that is, the recording operation including the formation of the recording track corresponding to additional recording or the recording track during the start of additional recording.

It should be understood that various changes and modifications to the presently preferred example embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A recording apparatus comprising:
a laser; and
a controller operatively coupled to the laser, the controller being configured to, in cooperation with the laser, record a second recording track on a recording medium which includes a first recording track which was previously recorded on the recording medium, the second recording track being gradually enlarged until a first separation distance exceeds a distance which corresponds to at least twice a number of maximum deviation tracks of the first recording track.

2. The recording apparatus of claim 1, wherein the second recording track is gradually enlarged based on a variable track pitch control.

3. The recording apparatus of claim 1, wherein the second recording track is gradually enlarged based on a fixed track pitch control.

4. The recording apparatus of claim 3, wherein the controller is configured to, based on a defect of the recording medium, record the second recording track at a position which is separated from an end position of the first recording track by a second separation distance.

5. The recording apparatus of claim 2, wherein the controller is configured to, after the second recording track is recorded, record a third recording track on the recording medium, the third recording track being gradually enlarged until a third separation distance exceeds a distance which corresponds to at least twice the number of maximum deviation tracks of the first recording track.

6. The recording apparatus of claim 5, wherein the third recording track is gradually enlarged based on a variable track pitch control.

7. The recording apparatus of claim 2, wherein the controller is configured to, after the second recording track is recorded, record a third recording track on the recording medium, the third recording track being gradually enlarged based on a fixed track pitch control.

8. The recording apparatus of claim 3, wherein the controller is configured to, after the second recording track is recorded, record a third recording track on the recording medium, the third recording track being gradually enlarged based on a fixed track pitch control.

9. The recording apparatus of claim 5, wherein the controller is configured to, after the third recording track is recorded, record a fourth recording track on the recording medium, the fourth recording track being gradually enlarged based on a fixed track pitch control.

10. The recording apparatus of claim 1, wherein the number of maximum deviation tracks is determined using a deviation amount which is based on:
(a) a tilt state between the recording medium and an optical pickup; and
(b) an eccentric state of the recording medium.

11. The recording apparatus of claim 1, wherein the second recording track includes dummy data.

12. The recording apparatus of claim 1, wherein the laser includes:
(a) a first laser configured to irradiate a recording laser beam; and
(b) a second laser configured to irradiate a servo laser beam.

13. The recording apparatus of claim 12, which includes a servo circuit operatively coupled to the controller such that the controller is configured to perform tracking servo control of the recording laser beam.

14. The recording apparatus of claim 12, which includes an optical pickup which includes the first laser and the second laser.

15. The recording apparatus of claim 1, wherein the recording medium includes a bulk layer and a reference surface.

16. A method of operating a recording apparatus including a laser, the method comprising:
recording a second recording track on a recording medium which includes a first recording track which was previously recorded on the recording medium, the second recording track being gradually enlarged until a first separation distance exceeds a distance which corresponds to at least twice a number of maximum deviation tracks of the first recording track.

17. The method of claim 16, wherein the second recording track is gradually enlarged based on a variable track pitch control.

18. The method of claim 16, wherein the second recording track is gradually enlarged based on a fixed track pitch control.

19. The method of claim 18, which includes recording, based on a defect of the recording medium, the second recording track at a position which is separated from an end position of the first recording track by a second separation distance.

20. The method of claim 17, which includes, after the second recording track is recorded, recording a third recording track on the recording medium, the third recording track being gradually enlarged until a third separation distance exceeds a distance which corresponds to at least twice the number of maximum deviation tracks of the first recording track.

21. The method of claim 20, wherein the third recording track is gradually enlarged based on a variable track pitch control.

22. The method of claim 17, which includes, after the second recording track is recorded, recording a third recording track on the recording medium, the third recording track being gradually enlarged based on a fixed track pitch control.

23. The method of claim 18, which includes, after the second recording track is recorded, recording a third recording track on the recording medium, the third recording track being gradually enlarged based on a fixed track pitch control.

24. The method of claim 20, which includes, after the third recording track is recorded, recording a fourth recording track on the recording medium, the fourth recording track being gradually enlarged based on a fixed track pitch control.

25. The method of claim 16, wherein the number of maximum deviation tracks is determined using a deviation amount which is based on:
(a) a tilt between the recording medium and an optical pickup; and
(b) an eccentric state of the recording medium.

26. The method of claim 16, wherein the second recording track includes dummy data.

27. The method of claim 16, wherein the laser includes:
(a) a first laser configured to irradiate a recording laser beam; and
(b) a second laser configured to irradiate a servo laser beam.

28. The method of claim 27, which includes performing tracking servo control of the recording laser beam.

29. The method of claim 27, wherein an optical pickup includes the first laser and the second laser.

30. The method of claim 16, wherein the recording medium includes a bulk layer and a reference surface.
